(19) United States
(12) Patent Application Publication
(10) Pub. No.: US 2010/0123854 A1
(43) Pub. Date: May 20, 2010

(54) OPTICAL SHEET, ILLUMINATING DEVICE AND LIQUID CRYSTAL DISPLAY DEVICE

(75) Inventors: Masaya ADACHI, Hitachi (JP); Tatsuya Sugita, Takahagi (JP); Chieko Araki, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Maxell, Ltd.

(21) Appl. No.: 12/620,759

(22) Filed: Nov. 18, 2009

(30) Foreign Application Priority Data
Nov. 20, 2008 (JP) 2008-297281

(51) Int. Cl. G02F 1/1335; F21V 7/04; F21V 7/22

(52) U.S. Cl. 349/61; 362/609; 362/610; 362/607; 362/606; 362/620

(57) ABSTRACT

An illuminating device includes: a light guide plate for outputting light, which enters the light guide plate from one side surface, from a front surface of the light guide plate; an optical sheet disposed on the front surface of the light guide plate; and a reflection sheet disposed on a rear surface of the light guide plate. The optical sheet includes prism arrays which are provided on a surface of the optical sheet opposite to the light guide plate, and each of which has at least two inclined surfaces and a ridge line extending in one direction. The light guide plate changes a polarization state of light that is reflected by the surface of the optical sheet, is transmitted through the light guide plate, is reflected by the reflection sheet, is transmitted through the light guide plate again, and then enters the optical sheet.

### CROSS-REFERENCE TO RELATED APPLICATION

The present application claims priority from Japanese application JP2008-297281 filed on Nov. 20, 2008, the content of which is hereby incorporated by reference into this application.

### BACKGROUND OF THE INVENTION

1. Field of the Invention

The present invention relates to an illuminating device which functions as a planar light source, an optical sheet which is used in the illuminating device, and a liquid crystal display device which includes the illuminating device as a backlight.

2. Description of the Related Art

A display device is one of media for visually conveying information to people. In the recently advanced information society, the display device has become a material tool for people as well as the society. Specifically, a recent liquid crystal display device is dramatically improved in its performance and is employed as a display device for a cell-phone, a personal computer, a big screen TV, or the like. The typical liquid crystal display device includes a liquid crystal display panel and a backlight (illuminating device) which is placed behind the liquid crystal display panel in order to irradiate light onto the liquid crystal display panel.

The liquid crystal display panel adjusts a light transmission amount of light emitted from the backlight, thereby displaying an image on the liquid crystal display panel. A desired liquid crystal display panel includes a polarizer and controls a polarization state of light entering a liquid crystal layer to display a image because the image that has a high contrast ratio may be obtained with a relatively low driving voltage. The above-mentioned liquid crystal display panel may be, for example, a twisted nematic (TN) mode display panel, a super twisted nematic (STN) mode display panel, or an electrical controlled birefringence (ECB) mode display panel. Alternatively, the liquid crystal display panel may be an in-plane switching (IPS) mode display panel or a vertical aligned (VA) mode display panel which has a wide viewing angle as a feature. In any one of the above-mentioned display panels, the liquid crystal display panel includes a pair of transparent substrates, a liquid crystal layer which is sandwiched between the pair of transparent substrates, and a pair of polarizers, each of which is disposed on a surface of each of the transparent substrates opposite to a liquid crystal layer, and the polarization state of light entering the liquid crystal layer is changed to control the light intensity of the transmitted light, thereby displaying the image.

The polarizer has functions to absorb predetermined linearly polarized light components and to allow linearly polarized light, of which polarization plane is orthogonal to the predetermined linearly polarized light components, to transmit through the polarizer. Therefore, when light irradiated onto the liquid crystal display panel is unpolarized light, the polarizer of the liquid crystal display panel absorbs at least 50% of the illuminating light. That is, in the liquid crystal display device, when the light emitted from the backlight is the unpolarized light, about a half of the illuminating light is absorbed by the polarizer, i.e., is lost. In view of the above, it is important to reduce a ratio of the illuminating light from the backlight that is absorbed by the polarizer of the liquid crystal display panel in order to realize a liquid crystal display device capable of providing a brighter image or achieving a lower power consumption.

Examples of the backlight of the liquid crystal display device include an edge light type backlighting system (light guide panel type backlighting system), a direct type backlighting system (reflector plate type backlighting system) and a planar light source type backlighting system. Among others, the edge light type backlighting system is utilized in order to realize a thin backlighting system.

The backlight of the edge light type backlighting system includes a planar transparent plate which is called as a light guide plate, a linear or point light source provided at an edge of the light guide plate, an optical sheet, which is called as a prism sheet, for adjusting a traveling direction of light output from the light guide plate, a diffusion sheet, and the like. The light guide plate includes a function to widen light from the light source in a planar direction. The light output from the light guide plate normally has the maximum values (peaks) of a luminance and a luminous intensity in a direction at an angle between 60 and 80 degrees with respect to a direction of a perpendicular line (normal line) of the light outputting surface of the light guide plate. It is known that light, which is output from the light guide plate at an angle (peak angle) at which the luminance or the luminous intensity becomes the maximum value, contains more p-polarized light components than s-polarized light components.

In Japanese Patent No. 3299087, a illuminating device which is configured such that light, which is output from the light guide plate and contains relatively more p-polarized light components, is preferentially guided in a front direction by using a prism sheet. In this example, each of prism arrays of the prism sheet has two inclined surfaces. An inclination angle of the inclined surface which is relatively far from the light source has an angle that causes light, which is output from the light guide plate and contains relatively more p-polarized light components, to be output in the front direction. An inclination angle of the other inclined surface, which is relatively near the light source, has an angle within a range where the light, which is output from the light guide plate and contains relatively more p-polarized light components, does not enter. In this case, the illuminating light from the illuminating device contains polarized light, and hence such illuminating light is suitable for the backlight of the liquid crystal display device.

### SUMMARY OF THE INVENTION

It is known that light output from a light guide plate normally has an angle (peak angle) at which a luminance or a luminous intensity becomes the maximum value in a direction at an angle of a range between 60 and 80 degrees with respect to a direction of a perpendicular line (normal line) of a light outputting surface of the light guide plate, and light output at the peak angle or any angle in a range near the peak angle contains more p-polarized light components than s-polarized light components. This is attributed to a difference of a transmittance between the p-polarized light components and the s-polarized light components at an interface between the light guide plate and air.

The inventors of the present invention studied about an illuminating device (backlight) which used an optical sheet (hereinafter also referred to as “prism sheet”) including prism arrays, each of which had two inclined surfaces, in order to efficiently utilize light which was output from the light guide plate and contained relatively more p-polarized light components. The prism sheet was disposed such that a surface where the prism arrays were formed was directed to the opposite side of the light guide plate. The prisms were disposed such that a direction of ridge lines of the prisms (longitudinal direction of a prism groove) was in parallel with a side surface (end surface) of the light guide plate placed adjacent to a light source. Among the two inclined surfaces of each prism, an inclination angle of one inclined surface which was relatively far from the light source took an angle at which the light, which was output from the light guide plate and contained relatively more p-polarized light components, was output in the front direction, whereas an inclination angle of the other inclined surface that was relatively near the light sources took an angle in a range where the p-polarized light components of the light output from the light guide plate did not enter. A prism sheet including a polyethylene terephthalate (PET) film, which is relatively inexpensive and easy to handle, as a base material and a prism array formed on a surface of the PET film was used. As a result of the above-mentioned study, the inventors of the present invention found that a ratio of the p-polarized light components of the light output from the prism sheet would not be as high as expected in comparison with a ratio of the p-polarized light components when the light was output from the light guide plate.

In the above-mentioned conventional technique, the light, which is output obliquely from the light guide plate and contains relatively more p-polarized light components, is output in the front direction, thereby increasing the ratio of the p-polarized light components of the light. However, the conventional technique is merely an attempt to output the light containing relatively more p-polarized light components in the front direction, and there is no consideration on increasing an absolute light intensity of the p-polarized light. Even if the ratio of the p-polarized light components of the light output from the prism sheet becomes higher, an intensity of the p-polarized light components itself would not be increased. Therefore, there is a problem that the above-mentioned technique fails to sufficiently contribute to an improvement of brightness of an image when applied to a backlight of the liquid crystal display device.

The present invention has been made in consideration of the above-mentioned problems, and an object of the present invention is therefore to provide a prism sheet which may increase a degree of polarization (that is, increase a ration of the p-polarized light components) of the light output from the light guide plate, and to provide an illuminating device which may output illuminating light containing linearly polarized light components of high light intensity. Another object of the present invention is to realize a liquid crystal display device, which may provide a sufficient brightness but requires less power consumption, by using the above-mentioned illuminating device.

Further objects and inventive features of the present invention are described below in detail with reference to the description of the specification and the attached drawings.

The present invention employs the following means in order to attain the above-mentioned objects.

The present invention provides an optical sheet including:

prism arrays which are provided on one surface of the optical sheet, and each of which includes at least two inclined surfaces and a ridge line extending in one direction; and

s-polarization high reflecting means provided on a surface opposite to the surface on which the prism arrays are formed, for increasing a ratio of p-polarized light components of light which is transmitted through the optical sheet by increasing a reflection of s-polarized light components with respect to light which enters the opposite surface at a predetermined angle.

In the optical sheet, the s-polarization high reflecting means may include a layer which is made of a transparent material having a refractive index higher than that of a base material of the optical sheet and a thickness corresponding to the predetermined angle.

Also, in the optical sheet, the s-polarization high reflecting means may include an inclined surface which is inclined in a direction in which an incident angle, to the optical sheet, of the light coming from a direction crossing the direction of the ridge line of each of the prism arrays is made larger with respect to the surface on which the prism arrays are formed.

The present invention also provides another optical sheet including:

prism arrays which are provided on one surface of the optical sheet, and each of which has at least two inclined surfaces and a ridge line extending in one direction; and

a base material including a transparent medium by which no phase difference is produced with respect to a p-polarized light entering a surface opposite to the one surface at a predetermined incident angle.

In the other optical sheet, the transparent medium which forms the base material may have an optical anisotropy and a slow axis that is substantially in parallel with or substantially orthogonal to the direction of the ridge line of each of the prism arrays.

Also, in the other optical sheet, the transparent medium which forms the base material may have a biaxial anisotropy and the slow axis that is substantially in parallel with the direction of the ridge line of each of the prism arrays.

Alternatively, in the other optical sheet, the base material may include an optically isotropic transparent medium.

Further, in the other optical sheet, a portion of one side of the ridge line of each of the prism arrays may include at least three inclined surfaces, and at least one inclined surface among the three inclined surfaces may be inclined in an opposite direction with respect to other inclined surfaces when viewed from a front surface of the optical sheet.

The present invention also provides an illuminating device including:

a light guide plate for outputting light, which enters the light guide plate from one side surface, from a front surface of the light guide plate;

an optical sheet disposed on the front surface of the light guide plate; and

a reflection sheet disposed on a rear surface of the light guide plate,

in which a surface of the optical sheet opposite to the light guide plate includes prism arrays each having at least two inclined surfaces and a ridge line extending in a direction along the one side surface of the light guide plate, and

in which a surface of the optical sheet on a side of the light guide plate includes s-polarization high reflecting means for increasing a ratio of p-polarized light components of light which is transmitted through the optical sheet by increasing a reflection of s-polarized light components with respect to the light which is output from the light guide plate and travels in a direction with a predetermined angle with respect to the front surface of the light guide plate.

Also, in the illuminating device, the light guide plate may change a polarization state of light that is reflected by the surface of the optical sheet on the side of the light guide plate, is transmitted through the light guide plate, is reflected by the reflection sheet, is transmitted through the light guide plate again, and then enters the optical sheet.

Further, in the illuminating device, the light guide plate may convert at least a portion of the s-polarized light components reflected by the surface of the optical sheet on the side of the light guide plate into p-polarized light components before the light reflected by the reflection sheet enters the optical sheet again.

Further, in the illuminating device, the light guide plate may have a birefringence and a slow axis that is inclined with respect to the one side surface of the light guide plate.

Additionally, in the illuminating device, the predetermined angle may be an angle at which an index value with respect to an amount of the light which is output from the light guide plate becomes a maximum value.

In the illuminating device, the s-polarization high reflecting means may include a layer which is made of a transparent material having a refractive index higher than that of a base material of the optical sheet and a thickness corresponding to the predetermined angle.

Also, in the illuminating device, the s-polarization high reflecting means may include an inclined surface which is inclined in a direction in which an incident angle, to the optical sheet, of the light output from the light guide plate is made larger with respect to the surface on which the prism arrays are formed.

The present invention also provides another illuminating device including:

a light guide plate for outputting the light, which enters the light guide plate from one side surface, from a front surface of the light guide plate; and

an optical sheet disposed on the front surface of the light guide plate,

in which the optical sheet includes:
prism arrays which are provided on a surface of the optical sheet opposite to the light guide plate, and each of which has at least two inclined surfaces and a ridge line extending in a direction along the one side surface; and
a base material including a transparent medium by which no phase difference is produced with respect to a p-polarized light which enters a surface of the optical sheet on a side of the light guide plate at a predetermined incident angle.

In the other illuminating device, the transparent medium which forms the base material may have an optical anisotropy and a slow axis that is substantially in parallel with or substantially orthogonal to the direction of the ridge line of each of the prism arrays.

Further, in the other illuminating device, the transparent medium which forms the base material may have a biaxial anisotropy and the slow axis that is substantially in parallel with the direction of the ridge line of each of the prism arrays.

Alternatively, in the other illuminating device, the base material may include an optically isotropic transparent medium.

The present invention also provides a liquid crystal display device including:

an illuminating device; and

a liquid crystal display panel for displaying an image by controlling transmission of light from the illuminating device,

in which the illuminating device includes:
a light guide plate for outputting light, which enters the light guide plate from one side surface, from a front surface of the light guide plate;
an optical sheet disposed on the front surface of the light guide plate; and
a reflection sheet disposed on a rear surface of the light guide plate,

in which a surface of the optical sheet opposite to the light guide plate includes prism arrays each having at least two inclined surfaces and a ridge line extending in a direction along the one side surface,

in which a surface of the optical sheet on a side of the light guide plate includes s-polarization high reflecting means for increasing a ratio of p-polarized light components of light which is transmitted through the optical sheet, by increasing a reflection of s-polarized light components with respect to the light which is output from the light guide plate and travels in a direction at a predetermined angle with respect to the front surface of the light guide plate, and

in which the liquid crystal display panel includes a polarizer which is disposed on a side of the illuminating device, the polarizer having an absorption axis that is oriented in a direction according to the direction of the ridge line of each of the prism arrays.

The present invention also provides another liquid crystal display device including:

an illuminating device; and

a liquid crystal display panel for displaying an image by controlling transmission of light from the illuminating device;

in which the illuminating device includes:
a light guide plate for outputting light, which comes from one side surface of the light guide plate, from a front surface of the light guide plate; and
an optical sheet disposed on the front surface of the light guide plate,

in which the optical sheet includes:
prism arrays which are provided on a surface of the optical sheet opposite to the light guide plate, and each of which has at least two inclined surfaces and a ridge line extending in a direction along the one side surface; and
a base material including a transparent medium by which no phase difference is produced with respect to a p-polarized light which enters a surface of the optical sheet on a side of the light guide plate at a predetermined incident angle, and

in which the liquid crystal display panel includes a polarizer disposed on a side of the illuminating device, the polarizer having an absorption axis that is oriented in a direction according to the direction of the ridge line of each of the prism arrays.

Means other than the above become apparent from the description below.

According to the present invention, an illuminating device which emits illuminating light with a highlight intensity of linearly polarized light components may be realized. Further, by using the illuminating device, a liquid crystal display device which may provide sufficient brightness but requires less power consumption may be realized.

### BRIEF DESCRIPTION OF THE DRAWINGS

In the accompanying drawings:

FIG. 1 is a cross sectional view illustrating a main configuration of an illuminating device according to an exemplary embodiment of the present invention;

FIG. 2 is a top view schematically illustrating a configuration of the illuminating device according to the exemplary embodiment of the present invention;

FIG. 3 is an explanatory view illustrating a polar angle (viewing angle) of light that is output from a front surface of a light guide plate;

FIG. 4 is an enlarged cross sectional view illustrating a main portion of the illuminating device according to the exemplary embodiment of the present invention;

FIG. 5 is a cross sectional view illustrating an example of a prism formed on a prism sheet;

FIG. 6 is a view illustrating an example of results of calculating transmittance of p-polarized light when the p-polarized light enters a biaxial anisotropic transparent medium;

FIG. 7 is a view illustrating another example of results of calculating the transmittance of the p-polarized light when the p-polarized light enters the biaxial anisotropic transparent medium;

FIG. 8 is a view illustrating a further example of results of calculating the transmittance of the p-polarized light when the p-polarized light enters the biaxial anisotropic transparent medium;

FIG. 9 is a graph illustrating an example of results of calculating the transmittance of the p-polarized light at the polar angle of 76 degrees when the p-polarized light enters the biaxial anisotropic transparent medium;

FIG. 10 is a partially enlarged cross sectional view illustrating the prism sheet;

FIG. 11 is a graph illustrating an example of results of calculating a reflectance performed by s-polarization high reflecting means of the prism sheet;

FIG. 12 is a graph illustrating another example of results of calculating the reflectance performed by the s-polarization high reflecting means of the prism sheet;

FIG. 13 is a graph illustrating a further example of results of calculating the reflectance performed by the s-polarization high reflecting means of the prism sheet;

FIG. 14 is a graph illustrating a still further example of results of calculating the reflectance performed by the s-polarization high reflecting means of the prism sheet;

FIG. 15 is a graph illustrating a yet further example of results of calculating the reflectance performed by the s-polarization high reflecting means of the prism sheet;

FIG. 16 is a graph illustrating a yet further example of results of calculating the reflectance performed by the s-polarization high reflecting means of the prism sheet;

FIG. 17 is a cross sectional view schematically illustrating a main configuration of the illuminating device according to the exemplary embodiment of the present invention;

FIG. 18 is a partially enlarged cross sectional view illustrating a modification example of the prism sheet; and

FIG. 19 is a cross sectional view schematically illustrating a configuration of a display device according to the exemplary embodiment of the present invention.

### DETAILED DESCRIPTION OF THE INVENTION

A main configuration of an illuminating device according to an exemplary embodiment of the present invention is schematically described below. The illuminating device according to the exemplary embodiment includes at least a light source, a light guide plate which has one end surface (side surface) placed adjacent to the light source and outputs light coming from the end surface from a front surface (light outputting surface) of the light guide plate, an optical sheet (hereinafter also referred to as prism sheet) including prism arrays each having at least two inclined surfaces and ridge line extending in one direction (a direction along the end surface of the light guide plate from which light enters), and a reflection sheet.

The main configuration of the illuminating device according to the exemplary embodiment is as follows.

(Configuration 1) A light guide plate is used, in which an output angle of light, which is output from the light outputting surface of the light guide plate, is in a range between 60 and 80 degrees with respect to a direction of a perpendicular line of the light outputting surface of the light guide plate when the luminance or the luminous intensity of the light becomes the maximum value.

(Configuration 2) The optical sheet (prism sheet) includes prism arrays on a surface (front surface) of the optical sheet opposite to the light guide plate in order to refract the light in a front direction (the direction of the perpendicular line of the light outputting surface of the light guide plate) when the light enters the optical sheet at an angle at which the luminance or the luminous intensity of light output from the light guide plate becomes the maximum value. Further, the prism sheet is made of a transparent medium which does not produce a phase difference with respect to the light when the light that has an angle at which the luminance or the luminous intensity of the light output from the light guide plate becomes the maximum value passes through the prism sheet.

(Configuration 3) A surface (rear surface) of the prism sheet on a side of the light guide plate is configured so that more p-polarized light components are transmitted, whereas more s-polarized light components are reflected with respect to the light having an angle at which the luminance or the luminous intensity of the light output from the light guide plate becomes the maximum value. At this time, there is not necessarily a difference in reflectance between the s-polarized light and the p-polarized light with respect to the light perpendicularly entering the prism sheet.

(Configuration 4) The light guide plate is made of a transparent medium which changes a polarization state of light which is reflected on the rear surface of the prism sheet, is transmitted through the light guide plate, is reflected by the reflection sheet, and then is transmitted through the light guide plate again to be oriented to the prism sheet. For example, the light guide plate is an anisotropic transparent medium which has a slow axis in a direction (oblique direction with respect to the end surface placed adjacent to the light source) other than a direction in parallel with or orthogonal to the end surface placed adjacent to the light source.

With the above-mentioned configuration, the illuminating device according to the exemplary embodiment is operated as follows.

With Configuration 1, output light containing more p-polarized light components with respect to the light outputting surface of the light guide plate than the s-polarized light components is obtained, as the output light output from the light guide plate. This is achieved because of the difference of transmittance between the p-polarized light components and the s-polarized light components at an interface between the light guide plate and air, which is known to the public. For example, when the output light is output from the light guide plate at the peak angle of the luminance (output angle of light of which luminance is the maximum value) in a range between 75 and 80 degrees, output light containing a high ratio of the p-polarized light components having a degree of polarization of about a range between 10 and 20% at a peak angle of the luminance, may be obtained.

The degree of polarization is defined as described below. The degree of polarization ρ is expressed by the following formula (formula (1)) provided that the luminance of the light output from the light guide plate, prism sheet, or the like is measured through an analyzer (polarizer), while the analyzer is rotated, thereby obtaining the maximum luminance Imax and the minimum luminance Imin.

ρ=(Imax−Imin)/(Imax+Imin) (1)

With Configuration 2, when light, which has an angle at which the luminance or the luminous intensity of the light output from the light guide plate becomes the maximum value, enters the prism sheet and output in the front direction, the light may be advanced within the prism sheet without changing the polarization state of the light. Therefore, the p-polarized light passing through the prism sheet may keep the state of the p-polarized light. The light entering the prism sheet is refracted at two points, i.e., the rear surface and the front surface of the prism sheet, at the interface between the prism sheet and air. At the time of the refraction, since the transmittance of the p-polarized light components becomes higher than that of the s-polarized light components, the light output from the prism sheet comes to contain relatively more p-polarized light components.

Consequently, with Configuration 1 and Configuration 2, the light, which is output from the light guide plate and contains relatively more p-polarized light components, is kept as it is, i.e., the polarization state of the light does not change, when the light passes through the prism sheet. In the refraction at the interface between the rear surface and the front surface of the prism sheet and air, the transmittance of the s-polarized light components is lower than that of the p-polarized light components, and hence the light output from the prism sheet comes to contain more p-polarized light components than the light output from the light guide plate.

In Configuration 3, a reflection amount of the s-polarized light components is actively increased on the rear surface of the prism sheet. Generally, when light obliquely enters the interface of the transparent medium having a different refractive index, the s-polarized light components are reflected more than the p-polarized light components. Therefore, the light, which has an angle at which the luminance or the luminous intensity of the light output from the light guide plate becomes the maximum value, obliquely enters the prism sheet, and hence the s-polarized light components of the light are reflected more than the p-polarized light components on the rear surface of the prism sheet. According to Configuration 3, the s-polarized light components of the light, which has the angle at which the luminance or the luminous intensity of the light output from the light guide plate becomes the maximum value, are reflected relatively more on the rear surface of the prism sheet. With the s-polarized light components being reflected relatively more on the rear surface of the prism sheet, the light output from the prism sheet comes to contain the higher ratio of the p-polarized light components than the light which is output from the light guide plate.

According to Configuration 4, a polarization state of light that is output from the light guide plate, reflected by the rear surface of the prism sheet, and then reflected by the reflection sheet to be oriented to the prism sheet again is changed. In other words, s-polarized light, that is output from the light guide plate and reflected by the rear surface of the prism sheet, is converted into light having a polarization state that is different from the s-polarized light, more preferably into the p-polarized light, to thereby realize increase of a light intensity of the p-polarized light components which passes through the prism sheet.

Especially when Configuration 3 is combined with Configuration 4, most of the s-polarized light components of the light that is output from the light guide plate are reflected by the rear surface of the prism sheet. The s-polarized light that is reflected by the rear surface of the prism sheet enters the prism sheet again through the light guide plate and the reflection sheet. However, when the light passes through the light guide plate, a phase difference produced by the optical anisotropy of the light guide plate changes the polarization state of the light. Accordingly, the light, which is once reflected by the rear surface of the prism sheet and enters the prism sheet again, becomes light containing the p-polarized light components and passes through the prism sheet to be utilized as illuminating light. More specifically, at least a portion of the s-polarized light, which is reflected by the rear surface of the prism sheet, is converted into the p-polarized light and may be utilized as the illuminating light, and hence the p-polarized light components of the light, which is output from the illuminating device, may be increased in light intensity.

As described above, by utilizing the illuminating device which includes a part of or all the elements of Configurations 2 through 4 in addition to the elements of Configuration 1, the illuminating light containing a predetermined linearly polarized light components (p-polarized light components) of high light intensity may be obtained.

Hereinafter, the exemplary embodiment of the present invention is described with reference to the attached drawings. However, the exemplary embodiment of the present invention is not limited to what is described below and may include various modifications. Some of the examples described below may be used in combination.

[Illuminating Device]

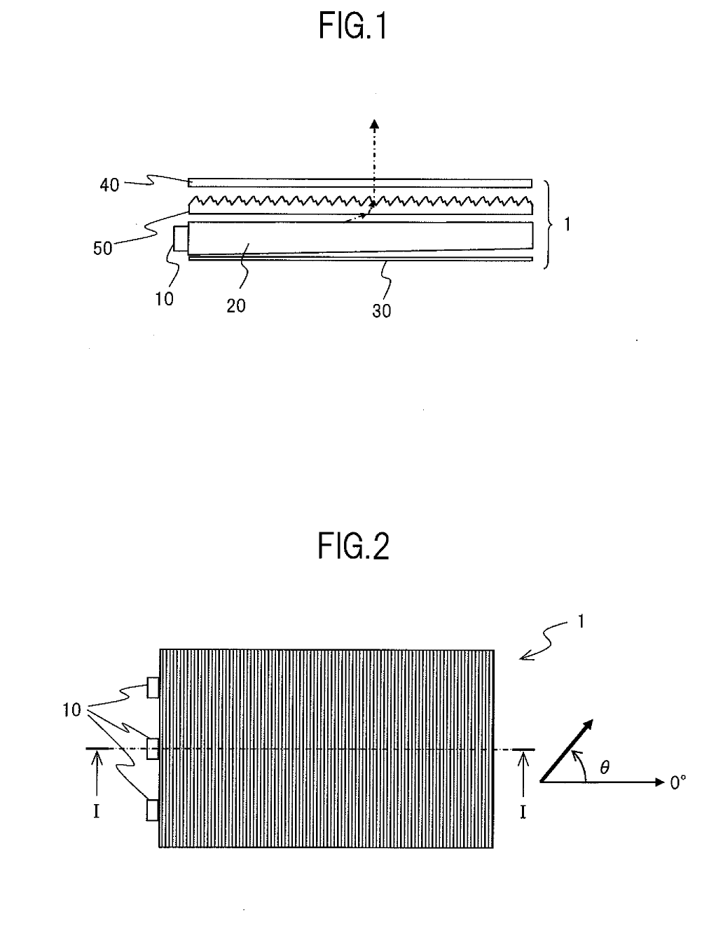

FIG. 1 is a cross sectional view illustrating a main configuration of an illuminating device 1 according to an exemplary embodiment of the present invention. FIG. 2 is a top view schematically illustrating the configuration of the illuminating device 1. In FIG. 2, a definition of an azimuth angle θ described below is also illustrated. The illuminating device 1 according to this exemplary embodiment is formed into a thinner shape, and is capable of emitting illuminating light containing a high ratio of predetermined polarized light components. Thus, the illuminating device 1 is suitable in use for a backlight of a liquid crystal display device. The backlight irradiates a display area of a liquid crystal display panel (not shown) with light from therebehind, and it is desired that a light outputting surface of the backlight be formed into about the same shape as the display area in order to illuminate the display area in just proportion.

The illuminating device 1 includes a light guide plate 20, light sources 10 that are arranged in adjacent to one end surface of the light guide plate 20, a reflection sheet 30 which is disposed on a rear surface of the light guide plate 20 and functions as light reflective means, and a prism sheet 50 which is disposed on a front surface of the light guide plate 20 so as to cover substantially the entire front surface of the light guide plate 20 and functions as light control means. If required, a diffusion sheet 40, which has a function to diffuse light passing through the diffusion sheet 40, may be disposed on a front surface of the prism sheet 50. In FIG. 1, an example of a light path of light, which is output from the light guide plate 20, is illustrated with an alternate long and short dash line. In this specification, a direction in which light is output from the illuminating device 1 (upward direction on the sheet of FIG. 1) is defined as the front surface, and an opposite direction (downward direction on the sheet of FIG. 1) is defined as the rear surface. In order to actually manufacture the illuminating device, a mechanical structure such as a frame, a power source necessary for allowing the light sources to emit light, and an electrical structure such as wiring are required. However, typical means may be employed as those elements, and hence detailed descriptions thereof are omitted in this specification.

Preferably, each light source 10 satisfies conditions of a small size, a high luminous efficiency, and low heating. For example, the light source 10 which satisfies the above-mentioned conditions suitably includes a fluorescent lamp and a light emitting diode (LED). In the following description, the LED is utilized as the light source 10, but the present invention is not limited thereto. When the LED is utilized as the light source 10, the required numbers of the LEDs are disposed side by side on the end surface of the light guide plate 20 (three light sources are illustrated in FIG. 2, but the present invention is not limited thereto) because the LEDs are formed as point-like light sources. Alternatively, an optical element, which converts light from the LEDs into linear light, may be disposed between the LEDs and the light guide plate 20. In any case, the light sources 10 are disposed on the one end surface of the light guide plate 20.

The LED emitting white color light may be used as the light source 10. An example of such LED includes an LED in which a blue color light-emitting element is combined with a phosphor which emits yellow color light by being exited with the blue color light, thereby realizing a white color illumination. Alternatively, there may be utilized an LED which may realize the white illumination having luminescence peaks in blue, green and red colors by combining a blue color light-emitting element or an ultraviolet light-emitting element with a phosphor which emits light by being excited with the light emitted from the blue color light-emitting element or the ultraviolet light-emitting element.

When a display device including the illuminating device 1 realizes a full-color display by an additive color mixing, it is preferable to use, as the light sources 10, LEDs which emit three primary colors of red, blue, and green. For example, when a full-color liquid crystal display panel is used to be irradiated with the illuminating light, a display device with a wider color reproduction range may be realized by using the light sources which have a luminescence peak wavelength corresponding to a transmission spectrum of a color filter of the liquid crystal display panel. Alternatively, when the full-color display is realized by a color field sequential, the color filter which is a cause of an optical loss is not necessary for the liquid crystal display panel, and hence a display device with less optical loss and a wider color reproduction range may be realized by using the LEDs which emit the three primary colors of red, blue, and green.

The light sources 10 are connected to a power source and control means which controls ON/OFF of the light sources 10 (either not shown) through wiring.

The light guide plate 20 allows the light, which is emitted from the light sources 10 to enter the light guide plate 20 from the one end surface of the light guide plate 20, to propagate within the light guide plate 20 and to be partially output from the front surface of the light guide plate 20, thereby achieving a function to output the light in plane. For this purpose, the light guide plate 20 is made of a substantially square-shaped plate-like member transparent to visible light, and is configured to allow the light, which enters the light guide plate 20 from the end surface of the light guide plate 20 and propagates within the light guide plate 20, to be output from the front surface of the light guide plate 20. A publicly known technology may be used in the configuration for outputting the light, which propagates within the light guide plate 20, from the front surface of the light guide plate 20. For example, the above-mentioned configuration may be realized by a configuration in which a traveling angle of the light, which is propagating within the light guide plate, is changed by providing, on the rear surface of the light guide plate 20, minute steps, an uneven shape, a lens shape, dot printing by using a white pigment, or the like. In consideration of a manufacturing cost of the light guide plate 20 or efficiency of the light which is output from the light guide plate 20, it is desired to form minute steps, an uneven shape, a lens shape or the like on the rear surface or the front surface of the light guide plate 20 in order to change the traveling angle of the light propagating within the light guide plate 20.

A resin material transparent to visible light may be used as a material of the light guide plate 20. Examples of the material include an acrylic resin, a polycarbonate resin, and a cyclic olefin resin. It is desired that the light guide plate 20 have a birefringence for the reasons as described below. To cause the light guide plate 20 to have the birefringence, for example, a uniaxially stretched transparent resin is used as a base material and a front surface or a rear surface of the base material is provided with minute steps or an uneven shape in order to cause the light, which propagates within the light guide plate 20, to be output from the front surface of the light guide plate 20, thereby manufacturing the light guide plate 20. Alternatively, when the light guide plate 20 is manufactured by injection molding, the light guide plate may be molded so as to allow a stress to be remained within the light guide plate 20 so that the light guide plate has the birefringence.

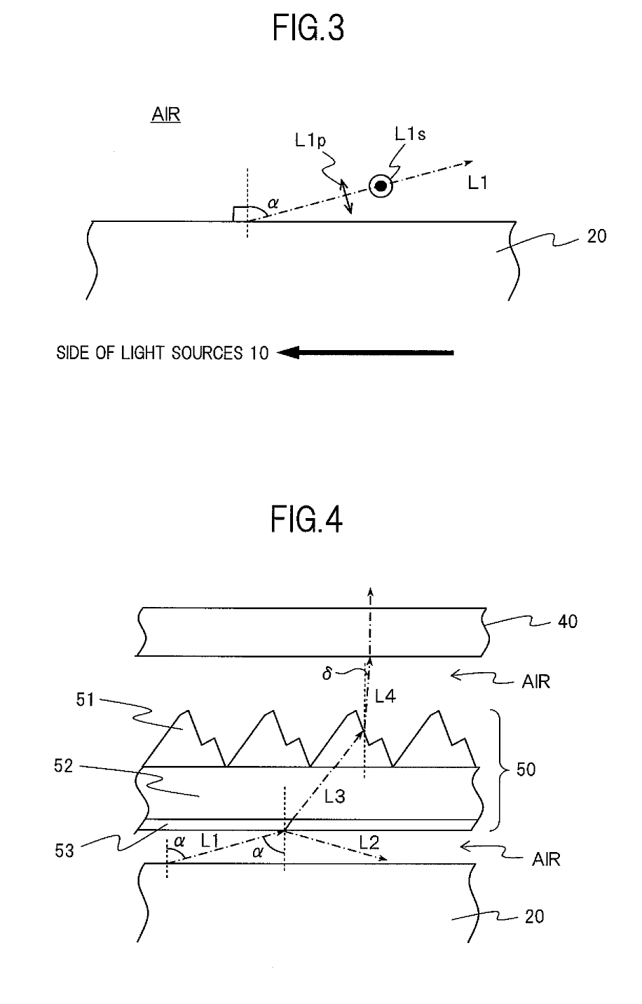

As illustrated in FIG. 2 (top view illustrating the illuminating device 1 viewed from its front surface), the azimuth angle θ is defined as an angle in a counterclockwise direction when the illuminating device 1 is viewed from the top and a direction opposite to the end surface of the light plate 20 on which the light sources 10 are disposed has the azimuth angle of 0 degrees. In other words, a direction of the azimuth angle of 0 degrees is a direction in which the light which has been emitted from the light sources 10 enters the light guide plate 20. Further, as illustrated in FIG. 3, a polar angle (viewing angle) α of the light, which is output from the front surface of the light guide plate 20, is defined as an inclination from a direction of a perpendicular line of the light outputting surface (i.e., the front surface) of the light guide plate 20 when the direction of the perpendicular line has the polar angle of 0 degrees.

In the illuminating device 1 according to this exemplary embodiment, the light guide plate 20 is used, in which an index value regarding the intensity of light output from the front surface of the light guide plate 20 (for example, luminance or luminous intensity) becomes the maximum value in a direction that the azimuth angle θ is almost 0 degrees and the polar angle α is in a range between 60 and 80 degrees when the light from the light sources 10 enters the light guide plate 20 from the end surface of the light guide plate 20. The above-mentioned light guide plate 20 may be realized by forming on the rear surface of the light guide plate 20 a plurality of steps to have an inclination angle of within a range between 0.5 and 3 degrees with respect to the light outputting surface of the light guide plate 20.

When an output angle of the light output from the light guide plate 20, with which the luminance or luminous intensity becomes the maximum value, is inclined with respect to the direction of the perpendicular line (normal line) of the light outputting surface of the light guide plate 20, the light output at the output angle contains more p-polarized light components. As illustrated in FIG. 3, a linearly polarized light component in which the vibration direction of the electric vector of the light is contained in a plane including the perpendicular line (normal line) of the light outputting surface of the light guide plate 20 and a traveling direction of light L1 which is output from the light guide plate 20 at a certain output angle is defined as p-polarized light L1p, and a linearly polarized light component in which the vibration direction of the electric vector of the light is orthogonal to that of the p-polarized light L1p is defined as s-polarized light L1s, respectively, of the light L1. As described above, the luminance or the luminous intensity of the light L1 which is output from the light guide plate 20 becomes the maximum value when the azimuth angle θ in the traveling direction of the light L1 is 0 degrees. Therefore, light traveling in this direction is aimed at in the following description. Unless otherwise stated, the linearly polarized light in which the vibration direction of the electric vector of the light is contained within a plane which includes the perpendicular line (normal line) of the light outputting surface of the light guide plate 20 and a direction of the azimuth angle θ of 0 degrees is referred to as the p-polarized light, and the linearly polarized light in which the vibration direction of the electric vector of the light is orthogonal to that of the p-polarized light is referred to as the s-polarized light. As described above, in the light which is output in a direction inclined with respect to the direction of the perpendicular line of the light outputting surface of the light guide plate 20, it is well known that the p-polarized light components become larger than the s-polarized light components because there is a difference in transmittance between the p-polarized light and the s-polarized light when the light is refracted at the interface between the light guide plate 20 and an air layer (symbolized by AIR in FIG. 3 and FIG. 4).

A degree of polarization p is expressed by the following formula (formula (1)) provided that the luminance of the light which is output from the light guide plate or a prism sheet is measured through an analyzer (polarizer), while the analyzer is rotated, to obtain the maximum luminance Imax and the minimum luminance Imin.

ρ=(Imax−Imin)/(Imax+Imin) (1)

In the following description, a degree of polarization with respect to the p-polarized light (degree of polarization of the p-polarized light) ρp is defined by the following formula (formula (2)) provided that the luminance of when an absorption axis of the analyzer is orthogonal to the p-polarized light is Ipmax and the luminance of when the absorption axis of the analyzer is in parallel with the p-polarized light is Ipmin.

ρp=(Ipmax−Ipmin)/(Ipmax+Ipmin) (2)

In the following description, such a light guide plate 20 is exemplified that the angle α at which the luminance of the light L1 becomes the maximum value is 77 degrees and the angle α at which the luminous intensity becomes the maximum value is 68 degrees, but the present invention is not limited thereto. In this case, output light containing such a high ratio of p-polarized light can be obtained that the degree of polarization ρp of the p-polarized light in the light having the output angle α of 77 degrees is about 14%, and the degree of polarization ρp of the p-polarized light in the light having the output angle α of 68 degrees is about 7%.

The reflection sheet 30 as the light reflective means is disposed on the rear surface of the light guide plate 20. The reflection sheet 30 is used in order to efficiently use the light which is output from the rear surface of the light guide plate 20 by reflecting the light to a side of the light guide plate 20. Such reflection sheet 30 may be utilized that a reflective surface having a high reflectance is formed on a supporting base material such as a resin plate or a polymer film. The reflective surface is formed on the supporting base material with a metallic thin film having a high reflectance such as aluminum or silver by using an evaporation method, a sputtering method, or the like. Alternatively, the reflective surface is formed by forming a dielectric multilayer as a high reflecting layer on the supporting base material. Further alternatively, the reflective surface is formed by coating the supporting base material with a white pigment. Further, the reflective surface may be formed by laminating one another a plurality of transparent media having different refractive indexes, thereby causing the reflective surface to function as reflection means.

The front surface of the light guide plate 20 is provided with the prism sheet 50 so as to cover the entire front surface of the light guide plate 20. The prism sheet 50 functions as the light control means, which changes the traveling direction of the light which is output from the light guide plate 20. The prism sheet 50 in this exemplary embodiment also functions to increase the degree of polarization of the light which is output from the light guide plate 20 and entering the prism sheet 50 from the rear surface of the prism sheet 50.

The prism sheet 50 includes a plurality of prism arrays each having at least two inclined surfaces and a ridge line extending in one direction. As illustrated in FIG. 2, a direction of the ridge lines of the prisms is in parallel with a longitudinal direction of the end surface of the light guide plate 20 on which the light sources 10 are disposed (i.e., direction in which the azimuth angle substantially takes 90 degrees). The prism sheet 50 is disposed such that a surface on which the prism arrays are formed becomes a front surface. The prisms are formed such that, when light which is output from the light guide plate 20 and has an angle at which the luminance or the luminous intensity of the light becomes the maximum value enters the prisms, the traveling direction of the light is refracted in about the front direction (direction of the perpendicular line of the light outputting surface of the light guide plate). Further, the prism sheet 50 is made of a transparent medium which does not produce a phase difference, especially, with respect to the p-polarized light when the light, which is output from the light guide plate 20 and has the angle at which the luminance or the luminous intensity becomes the maximum value, passes through the prism sheet.

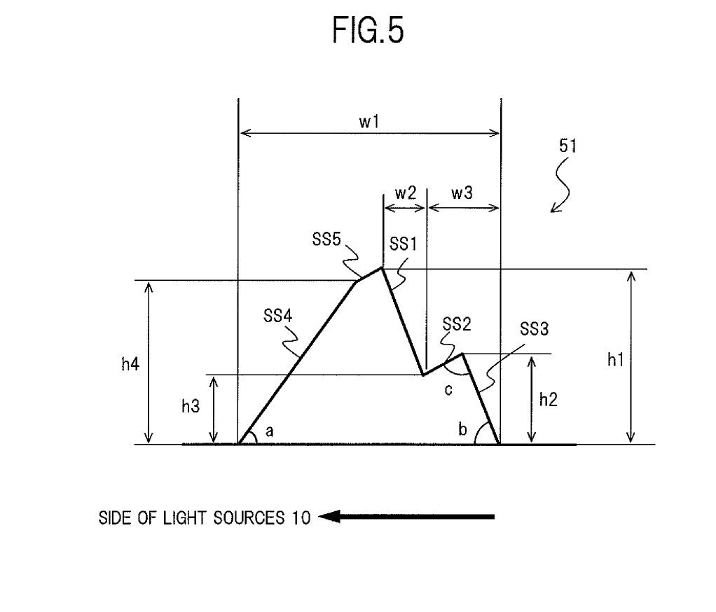

Then, a more detailed example of the prism sheet 50 is described below with reference to FIGS. 4 and 5. FIG. 4 is a cross sectional view illustrating a main portion of the illuminating device 1 according to this exemplary embodiment. In FIG. 4, the prism sheet 50 and the peripheral part of the prism sheet 50 of the cross sectional view of FIG. 1 are enlarged. FIG. 5 is a cross sectional view illustrating an example of a specific shape of a prism 51 formed on the front surface of the prism sheet 50.

In consideration with an industrial usability such as manufacturing of the prism sheet 50, it is actually efficient to form the prism sheet 50 in which a transparent film is used as a base material 52 and the prisms 51 are formed in arrays on the front surface of the prism sheet 50. The base material 52 is made of a transparent medium which does not produce a phase difference in the p-polarized light components of the light which passes through the prism sheet 50. In other words, by suppressing a loss of the p-polarized light components which is caused by a change of a state of the p-polarized light while passing through the prism sheet 50 after being output from the light guide plate 20, the light containing a higher ratio of the p-polarized light components is output from the prism sheet 50.

More specifically, for example, an optically isotropic transparent medium, such as a triacetylcellulose film or a non-stretched polycarbonate film, which has little birefringence within the film, may be used as the base material 52. Alternatively, by stretching a film made of the polycarbonate resin or the olefin resin in one direction, the transparent medium having a uniaxial anisotropy of the refractive index within the film may be used. In this case, however, it is important to set an angle of a slow axis of the base material 52 to an azimuth angle θ of 0 degrees (or 180 degrees), or 90 degrees (or 270 degrees) when disposing the prism sheet 50 so as not to produce the phase difference in the p-polarized light which passes through the prism sheet 50.

It is extremely industrially efficient to use a polyethylene telephthalate (PET) film, which is relatively inexpensive and easy to handle, as the base material 52 of the prism sheet 50. However, the PET film has a biaxial anisotropy, and hence a careful consideration is required so as not to produce the phase difference in the p-polarized light which passes through the prism sheet 50 when the PET film is used as the base material 52.

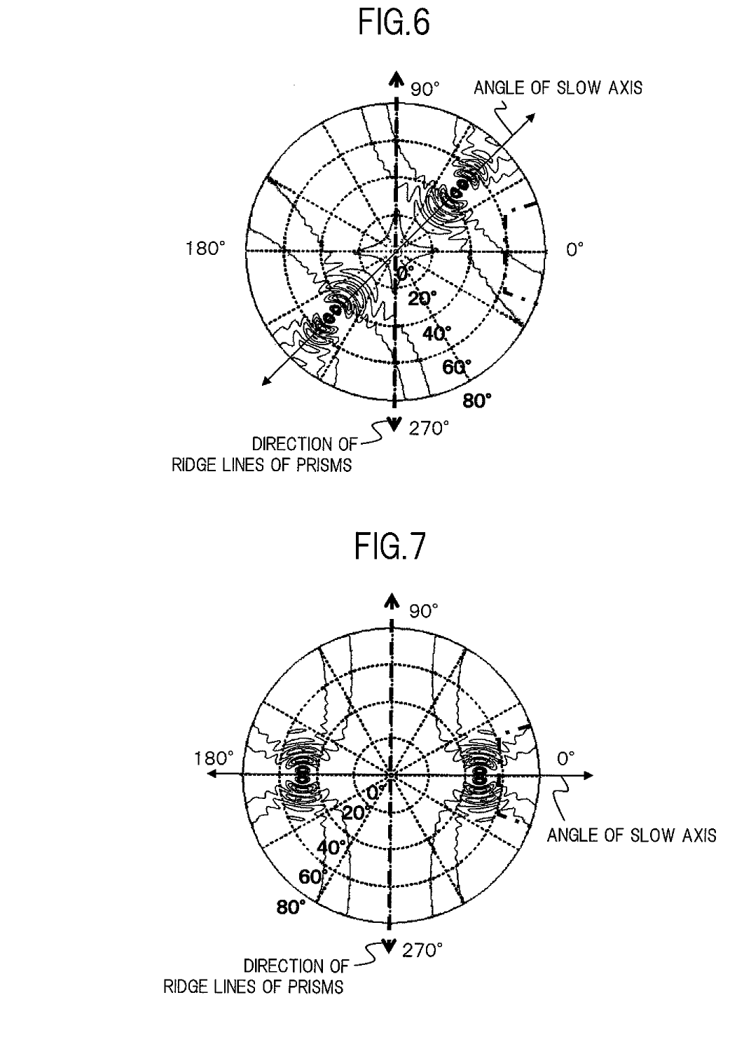

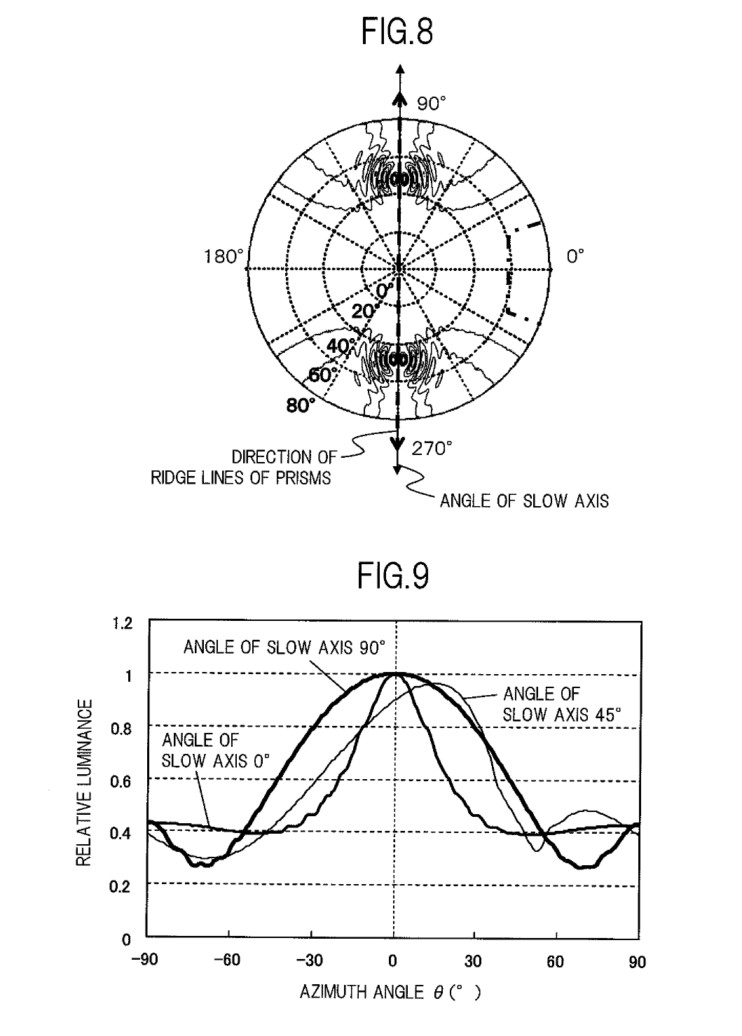

FIGS. 6, 7, and 8 each illustrate a result of simulation, which is illustrated by a contour line, that the transmittance of the p-polarized light (i.e., the linearly polarized light that a vibration direction of the electric vector of the light is contained within the plane including a direction of the azimuth angle θ of 0 degrees) is simulated within a range of all the azimuth angles (i.e., range between 0 and 360 degrees) and at the polar angles of a range between 0 and 80 degrees, when the p-polarized light enters the transparent medium, e.g., a PET film, of the biaxial anisotropy (principal refractive index: nx=1.68; ny=1.62; and nz=1.47, and a thickness of 50 μm). FIG. 6 illustrates a case where the slow axis angle of the transparent medium is the azimuth angle of 45 degrees (or 215 degrees). FIG. 7 illustrates a case where the slow axis angle of the transparent medium is the azimuth angle of 0 degrees (or 180 degrees). FIG. 8 illustrates a case where the slow axis angle of the transparent medium is the azimuth angle of 90 degrees (or 270 degrees).

In each of the above-mentioned cases, the transmittance of the p-polarized light is low in substantially concentric ranges around two optical axes which exist on the slow axis angle. The range in which the transmittance of the p-polarized light is low is a range in which a phase difference is produced with respect to the p-polarized light passing through the prism sheet 50 when the transparent medium is used as the base material 52 of the prism sheet 50. When the transparent medium is used as the base material 52 of the prism sheet 50, in consideration of an angle distribution of the light output from the light guide plate, an angle range to be especially studied with respect to the light which passes through the prism sheet 50 is the range of the azimuth angle θ of 0 degrees with a margin of ±15 degrees and the polar angle α of a range between 60 and 80 degrees (in FIGS. 6, 7, and 8, the angle range is illustrated by an alternate long and short dash line). A case where the slow axis angle of 90 degrees (or 270 degrees) in the above-mentioned range shows the least change of the polarization state of the p-polarized light. In other words, the most preferable condition is a case where a direction of the ridge lines of the prisms is in parallel with the slow axis angle of the transparent medium. Further description is made of the above with reference to FIG. 9.

FIG. 9 illustrates the transmittance of the p-polarized light of the simulation results which are illustrated in FIGS. 6, 7 and 8, especially of when the polar angle α of 76 degrees. More specifically, FIG. 9 illustrates a relationship between the traveling direction of the incident light and the transmittance of the light represented by a relative luminance. Further, in FIG. 9, three different patterns, i.e., the azimuth angle of 45 degrees (or 215 degrees), the azimuth angle of 0 degrees (or 180 degrees), and the azimuth angle of 90 degrees (or 270 degrees) are illustrated as a condition of the slow axis angle of the transparent medium. As illustrated in FIG. 9, in the case of the transparent medium of the biaxial anisotropy, the p-polarized light components are not reduced due to the phase difference in the p-polarized light which travels in the azimuth angle of 0 degrees at a predetermined polar angle when the slow axis angle is set to 0 degrees or 90 degrees. Further, when the slow axis angle is set to 90 degrees, the phase difference produced in the p-polarized light becomes less within a wider range of the azimuth angle including the azimuth angle of 0 degrees. Accordingly, a loss of the p-polarized light is suppressed.

When the transparent medium is used as the base material 52 of the prism sheet 50, an angle range to be especially studied with respect to the light which passes through the prism sheet 50 is the azimuth angle θ of 0 degrees with a margin of ±15 degrees and the polar angle α of a range between 60 and 80 degrees when considering an angle distribution of the light which is output from the light guide plate 20. Therefore, when the transparent medium of the biaxial anisotropy such as the PET film is used as the base material 52 of the prism sheet 50, it is desired that the slow axis angle of the transparent medium be set to the azimuth angle of 0 degrees (or 180 degrees), or the azimuth angle of 90 degrees (or 270 degrees), i.e., that the slow axis angle be made to be orthogonal to or in parallel with the direction of the ridge lines of the prisms 51. Further, as described above, if the slow axis angle is set to 90 degrees (or 270 degrees), the phase difference produced in the p-polarized light becomes less within a wider range of the azimuth angle including the azimuth angle of 0 degrees. Accordingly, more p-polarized light may be output from the prism sheet 50. In view of the above, it is desired that the slow axis angle be made to be in parallel with the direction of the ridge lines of the prisms 51. To produce better effect, it is desired that the direction of the ridge lines of the prisms and the slow axis angle be made to satisfy the above-mentioned conditions. However, fluctuation of quality may occur in actually manufactured products, resulting in causing a shift of the angle. In this case, variation in angle with a margin of about ±5 degrees would be in an acceptable range.

When the transparent medium of the biaxial anisotropy is used as the base material 52 of the prism sheet 50 as described above, there is produced a large difference in effect between when the slow axis angle is 0 degrees and when the slow axis angle is 90 degrees. On the contrary, when the transparent medium of the uniaxial anisotropy is used as the base material 52 of the prism sheet 50, a loss of the p-polarized light is suppressed in the same manner both when the slow axis angle is 0 degrees and when the slow axis angle is 90 degrees.

FIG. 5 is the cross sectional view illustrating the example of the specific shape of the prism 51 formed on the front surface of the prism sheet 50. In this exemplary embodiment, in order to suppress a color variation caused when a viewing angle (polar angle) is changed in the azimuth angle which is orthogonal to the direction of the ridge lines of the prisms 51, the following way is employed. More specifically, a cross sectional shape of the prism 51 includes a plurality of inclined surfaces with two main inclination angles, a portion relatively far from the light sources with respect to the vertex of the prism includes at least three inclined surfaces, and at least one of the three inclined surfaces is inclined in an opposite direction in comparison with the other inclined surfaces when viewing from the light outputting surface of the prism sheet 50.

The above-mentioned two main inclination angles include an angle of the inclined surface which is relatively far from the light sources with respect to the vertex of the prism 51 and an angle of the inclined surface which is relatively near the light sources with respect thereto. More specifically, the two main inclination angles include an inclination angle of the inclined surface on which the light is refracted in the front direction of the prism sheet 50 and an inclination angle of the inclined surface that the light seldom passes through, when the light, which is output from the light guide plate 20 and has the angle at which the luminance or the luminous intensity becomes the maximum value, enters the prism sheet 50. In this exemplary embodiment, the prism 51 has a cross sectional shape which includes five inclined surfaces (SS1 through SS5) combined with one another. When the light, which is output from the light guide plate 20 and has the angle at which the luminance or the luminous intensity becomes the maximum value, enters the prism sheet 50, the inclined surface with a main inclination angle at which the above-mentioned light passes through the prism sheet 50 corresponds to SS1 and SS3 of FIG. 5. When the light, which is output from the light guide plate 20 and has the angle at which the luminance or the luminous intensity becomes the maximum value, enters the prism sheet 50, the inclined surface with a main inclination angle at which the light does not pass through the prism sheet 50 corresponds to SS4 of FIG. 5. The inclined surface SS2 is the inclined surface that the light enters, which is output from the light guide plate and has the angle at which the luminance or the luminous intensity becomes the maximum value. However, the inclined surface SS2 refracts the light in a direction different from ones by the inclined surfaces SS1 and SS3, and is inclined in an opposite direction from the inclined surfaces SS1 and SS3. If a top end of the prism 51 is made into a sharp angle, a defect tends to occur in manufacturing the prism 51, and hence the inclined surface SS5 is formed in order to avoid the sharp angle of the top end of the prism 51.

Practical pitches between the prism arrays and practical heights of the prisms are about several tens μm. Specific size and inclination angle of the prism 51 may be selected in consideration with an optical simulation or the like according to the refractive index of the transparent medium which is a material of the base material 52 of the prism sheet 50 and the prisms 51.

For example, in this exemplary embodiment, a width w1 and a height h1 of the entire prism, respectively, are about 35 μm and about 25 μm. When the light, which is output from the light guide plate 20 and has the angle at which the luminance or the luminous intensity becomes the maximum value, enters the prism sheet, among the main inclination angles, an inclination angle b of the inclined surface on which the light is refracted in the front direction of the prism sheet is about 69 degrees, and an inclination angle a of the inclined surface that the light, which is output from the light guide plate 20 and has the angle at which the luminance or the luminous intensity becomes the maximum value, would not pass through is about 58 degrees. Other sizes defined in FIG. 5 are a width w2 of about 6 μm, a width w3 of about 12 μm, a height h2 of about 13 μm, a height h3 of about 9 μm, a height h4 of about 25 μm, and an angle c of 80 degrees.

When the prism 51 is made into the above-mentioned shape, if an average refractive index of the base material 52 of the prism sheet 50 is set to 1.65 and the refractive index of the prism 51 is set to 1.68, an angle δ of the light which is output from the inclined surfaces SS1 and SS3 of the prism sheet 50 becomes 0.5 degrees with respect to the light having an angle α of 77 degrees at which the luminance of the light output from the light guide plate 20 becomes the maximum value, i.e., the light is output to about a front of the illuminating device 1. Alternatively, if the average refractive index of the base material 52 is set to 1.65 and the refractive index of each prism 51 is set to 1.64, the angle δ of the light, which is output from the inclined surfaces SS1 and SS3 of the prism sheet 50, becomes 0.2 degrees with respect to the light having an angle α of 68 degrees at which the luminous intensity of the light output from the light guide plate 20 becomes the maximum value, i.e., the light is output to about the front of the illuminating device 1.

A portion of the light, which is output from the light guide plate 20 and has the angle at which the luminance and the luminous intensity becomes the maximum value, enters the prism sheet 50 and then passes through the inclined surface SS2 when the light is output. Here, most of the light which is output from the light guide plate 20 is refracted in the azimuth direction (azimuth angle of 180 degrees) where the light sources 10 are disposed. However, the portion of the light which passes through the inclined surface SS2 is refracted in the opposite azimuth direction (azimuth angle of 0 degrees). In this case, due to a wavelength dependence of the refractive index of the transparent medium which forms the prism sheet 50, parts of the color variation caused at the time of the refraction of the light are averaged. Accordingly, the color variation caused due to the wavelength dependence of the refractive index of the transparent medium may be suppressed.

The prism 51 is made of an optically isotropic transparent medium or a transparent medium which does not produce the phase difference which is detrimental to the p-polarized light passing through the transparent medium. This is because, as in the base material 52 of the prism sheet 50, by reducing the loss of the p-polarized light components due to a change of the state of the p-polarized light which is output from the light guide plate 20 and passes through the prism sheet 50, light containing a higher ratio of p-polarized light components is output from the prism sheet 50.

Any transparent medium such as an ultraviolet curable resin or a thermosetting resin may be used as the transparent medium which forms the prism 51 as far as the transparent medium satisfies the above-mentioned conditions. Further, to realize a desired refractive index, the transparent medium may contain fine particles, such as titanium oxide particles, which are transparent and have a high refractive index, as required. In this case, it is desired that each of the fine particles have a diameter of a range about between several nm and several tens nm so as to minimize scattering of light at least with respect to a visible wavelength area.

S-polarization high reflecting means 53 is provided on the rear surface of the prism sheet 50, as required. The s-polarization high reflecting means 53 is provided in order to reflect more s-polarized light components when the light, which is output from the light guide plate 20 and has an angle at which at least the luminance or the luminous intensity has the maximum value, enters the prism sheet 50. In other words, as compared with a case where a rear surface of the prism sheet 50 is formed only of the base material 52 which is planar and in parallel with the light outputting surface of the light guide plate 20 without the s-polarization high reflecting means 53, the s-polarization high reflecting means 53 has a function of reflecting more s-polarized light components of the light which is output from the light guide plate 20 at a predetermined angle. It is not necessary that the reflectance is different between the s-polarized light and the p-polarized light with respect to the light which perpendicularly enters the prism sheet 50. In order to realize such a configuration that more s-polarized light components are reflected with respect to the light perpendicularly entering the prism sheet 50, it is necessary, for example, to provide a plurality of layers having different birefringences laminated on one another. In this case, a thickness of the prism sheet 50 is increased, resulting in an increase in cost. On the other hand, in this exemplary embodiment, the s-polarization high reflecting means 53 may have such a configuration that more s-polarized light components are reflected particularly with respect to the light which is output from the light guide plate 20 and has the angle at which at least the luminance or the luminous intensity becomes the maximum value. In other words, the s-polarization high reflecting means 53 may be configured so as to reflect more s-polarized light components with respect to the light which obliquely enters the prism sheet 50. The s-polarization high reflecting means 53 may be realized, as described below, by a formation of a single layer for the prism sheet 50 or a modification of a shape of a surface of the prism sheet 50, and hence an increase in thickness of the prism sheet 50 or an increase in cost may be suppressed by the configuration of the s-polarization high reflecting means 53 as compared with the configuration in which more s-polarized light components are reflected with respect to the light perpendicularly entering the prism sheet 50.

FIG. 10 is a partially enlarged cross sectional view illustrating the prism sheet 50 and illustrates an example of the s-polarization high reflecting means 53. It is preferable to form the s-polarization high reflecting means 53 so as to include a transparent layer having a refractive index higher than that of the base material 52 of the prism sheet 50. The transparent layer has a thickness d which satisfies the following condition with respect to an angle of the light, which is output from the light guide plate 20, at which the luminance or the luminous intensity becomes the maximum value. Specifically, the thickness (film thickness) d may satisfy a formula (3) provided that the refractive index of the s-polarization high-reflecting means 53 is ns and an angle (inclination angle from a direction perpendicular to the light outputting surface of the light guide plate 20) at which the light, which is output from the light guide plate 20 and enters the prism sheet 50 at an angle at which the luminance or the luminous intensity becomes the maximum value, travels within the s-polarization high reflecting means 53 is ∈.

d=λ/(4·ns·cos ∈)·(2m+1) (3)

where λ represents a wavelength of the light and m represents an integral number equal to or larger than 0. The wavelength λ is a wavelength of visible light. For example, a value of 550 nm of a high photopic sensitivity may be used as a value of the wavelength λ. The film thickness d of the s-polarization high reflecting means 53 may be a value which may be obtained provided that a value of m is an integral number equal to or larger than 1. However, as the film thickness d becomes larger, an adverse effect of the wavelength dependence of the refractive index of the transparent medium, which forms the s-polarization high reflecting means 53, becomes larger. Therefore, it is desired to select a value which is calculated under a condition of m=0 as the film thickness d.

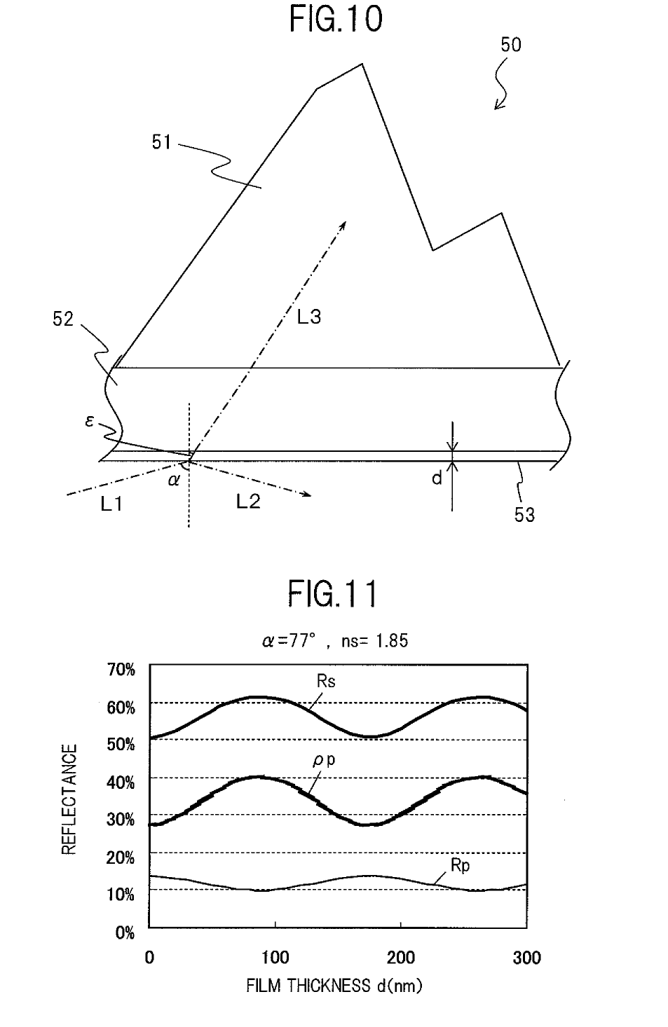

FIGS. 11 through 16 each illustrate results of a simulation that a film having a refractive index higher than that of the base material 52 of the prism sheet 50 is formed on the rear surface of the prism sheet 50 as the s-polarization high reflecting means 53. These simulation results may be obtained provided that the refractive index of the base material 52 is 1.65.

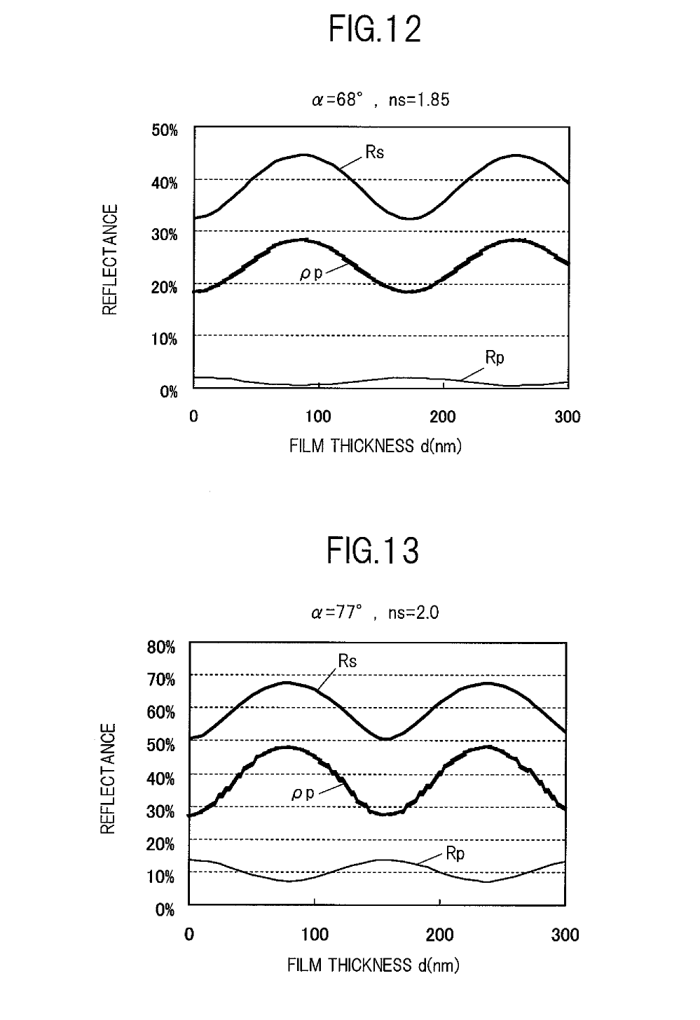

FIGS. 11 and 12 each illustrate a reflectance Rs of the s-polarized light, a reflectance Rp of the p-polarized light, and a degree of polarization ρp of the p-polarized light within the base material 52 of the prism sheet 50 with respect to the film thickness d, when the film having a refractive index ns of 1.85 is formed as the s-polarization high reflecting means 53. FIG. 11 illustrates a case where an incident angle of the light into the prism sheet 50 is 77 degrees. FIG. 12 illustrates a case where an incident angle of the light into the prism sheet 50 is 68 degrees. The s-polarization high reflecting means 53 is a film made of an inorganic material such as a silicon nitride material or a film made of a transparent material which is formed such that inorganic fine particles, such as titanium oxide particles, which are transparent and have a high refractive index, are combined with an organic material such as an ultraviolet curable resin material in order to increase the refractive index. When the fine particles are combined, it is desired that a diameter of each fine particle be set to a range between several nm and several tens nm so as to minimize scattering of the fine particles at least with respect to the light of the visible wavelength range.

When the incident angle of the light into the prism sheet 50 is 77 degrees, the reflectance Rp of the p-polarized light is about 14%, the reflectance Rs of the s-polarized light is about 51%, and the degree of polarization ρp of the p-polarized light within the base material 52 of the prism sheet 50 is about 27% in a state where there is no s-polarization high reflecting means 53 (i.e., state of d=0), as illustrated in FIG. 11. To the contrary, when a film having the reflective index ns of 1.85 is formed as the s-polarization high reflecting means 53, the state of reflection of the light at the rear surface of the prism sheet 50 varies according to the film thickness d. Specifically, the reflectance Rp of the p-polarized light decreases, the reflectance Rs of the s-polarized light increases, and the degree of polarization ρp of the p-polarized light within the base material 52 increases, as compared with a case where nothing is formed on the rear surface of the prism sheet. In particular, if the film thickness d (about 87 nm) which satisfies the condition of the formula (3) is selected, the reflectance Rp of the p-polarized light decreases to about 10%, the reflectance Rs of the s-polarized light increases to about 61%, and the degree of polarization ρp of the p-polarized light within the base material 52 increases to about 40%.

Further, when the incident angle of the light into the prism sheet 50 is 68 degrees, the reflectance Rp of the p-polarized light is about 2%, the reflectance Rs of the s-polarized light is about 32%, and the degree of polarization ρp of the p-polarized light within the base material 52 is about 18% in a state where there is no s-polarization high reflecting means 53 as illustrated in FIG. 12. To the contrary, when a film having the reflective index ns of 1.85 is formed as the s-polarization high reflecting means 53, the state of reflection of the light at the rear surface of the prism sheet 50 varies according to the film thickness d. Specifically, the reflectance Rp of the p-polarized light decreases, the reflectance Rs of the s-polarized light increases, and the degree of polarization ρp of the p-polarized light within the base material 52 of the prism sheet 50 increases, as compared with a case where nothing is formed on the rear surface of the prism sheet 50. In particular, if the film thickness d (about 86 nm) which satisfies the condition of the formula (3) is selected, the reflectance Rp of the p-polarized light decreases to about 0.6%, the reflectance Rs of the s-polarized light increases to about 44%, and the degree of polarization ρp of the p-polarized light within the base material 52 increases to about 28%.

In this case, a loss (reflection) of the p-polarized light components decreases and more s-polarized light components are reflected when the light, which is output from the light guide plate 20 and contains a high ratio of p-polarized light components, enters the prism sheet 50. Consequently, light containing a higher ratio of p-polarized light components may be obtained when the light is output to the side of the front surface of the prism sheet 50 than when the light is output from the light guide plate 20.

FIGS. 13 and 14 each illustrate the reflectance Rs of the s-polarized light, the reflectance Rp of the p-polarized light, and the degree of polarization ρp of the p-polarized light within the base material 52 of the prism sheet 50 with respect to the film thickness d, when the film having the refractive index ns of 2.0 is formed as the s-polarization high reflecting means 53. FIG. 13 illustrates a case where an incident angle of the light into the prism sheet 50 is 77 degrees. FIG. 14 illustrates a case where an incident angle of the light into the prism sheet 50 is 68 degrees. Used as the s-polarization high reflecting means 53 having the refractive index ns of 2.0 is a film made of an inorganic material such as a silicon nitride material or a film which is formed such that inorganic fine particles, such as titanium oxide particles, which are transparent and have a high refractive index, are combined with an organic material such as an ultraviolet curable resin material in order to increase the refractive index. When the fine particles are combined, it is desired that a diameter of each fine particle be set to a range between several nm and several tens nm so as to minimize scattering of the fine particles at least with respect to the light of the visible wavelength range.

As illustrated in FIG. 13, when the incident angle of the light entering the prism sheet 50 is 77 degrees, if the film thickness d (about 79 nm) which satisfies the condition of the formula (3) is selected, the reflectance Rp of the p-polarized light decreases to about 7%, the reflectance Rs of the s-polarized light increases to about 67%, and the degree of polarization ρp of the p-polarized light within the base material 52 of the prism sheet 50 increases to about 48%. As illustrated in FIG. 14, when the incident angle of the light entering the prism sheet 50 is 68 degrees, if the film thickness d (about 78 nm) which satisfies the condition of the formula (3) is selected, the reflectance Rp of the p-polarized light decreases to less than 0.1%, the reflectance Rs of the s-polarized light increases to about 52%, and the degree of polarization ρp of the p-polarized light within the base material 52 increases to about 35%.

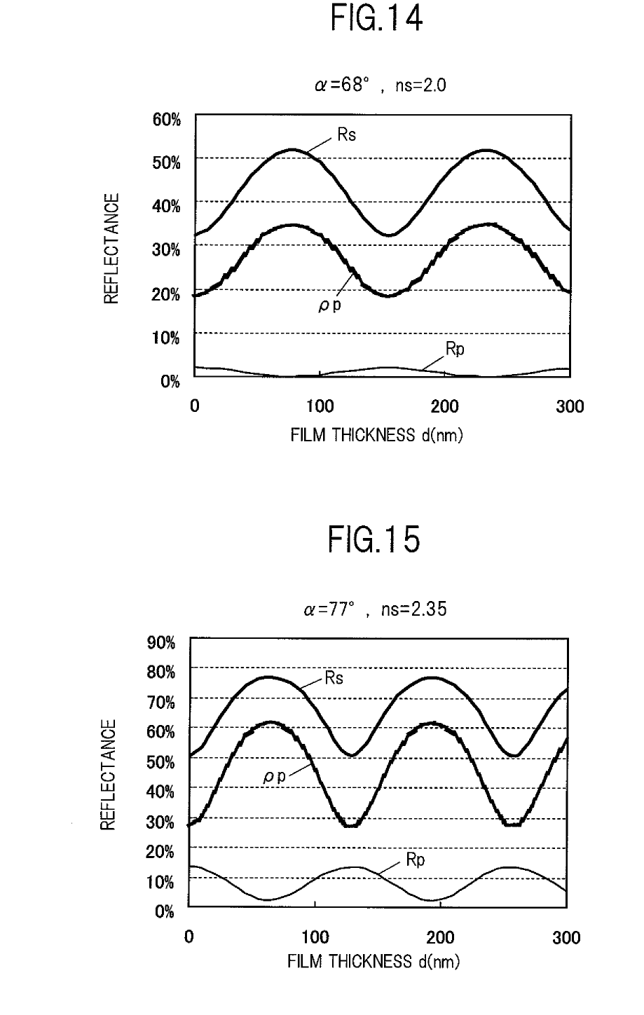

FIGS. 15 and 16 each illustrate the reflectance Rs of the s-polarized light, the reflectance Rp of the p-polarized light, and the degree of polarization ρp of the p-polarized light within the base material 52 of the prism sheet 50 with respect to the film thickness d, when the film having the refractive index ns of 2.35 is formed as the s-polarization high reflecting means 53. FIG. 15 illustrates a case where an incident angle of the light into the prism sheet 50 is 77 degrees. FIG. 16 illustrates a case where an incident angle of the light into the prism sheet 50 is 68 degrees. Used as the s-polarization high reflecting means 53 having the refractive index of 2.35 is titanium oxide, zinc sulfide or the like.

As illustrated in FIG. 15, when the incident angle of the light entering the prism sheet 50 is 77 degrees, if the film thickness d (about 64 nm) which satisfies the condition of the formula (3) is selected, the reflectance Rp of the p-polarized light decreases to about 2.5%, the reflectance Rs of the s-polarized light increases to about 77%, and the degree of polarization ρp of the p-polarized light within the base material 52 of the prism sheet 50 increases to about 61%. As illustrated in FIG. 16, when the incident angle of the light entering the prism sheet 50 is 68 degrees, if the film thickness d (about 64 nm) which satisfies the condition of the formula (3) is selected, the reflectance Rp of the p-polarized light decreases to about 1.1%, the reflectance Rs of the s-polarized light increases to about 64%, and the degree of polarization ρp of the p-polarized light within the base material 52 increases to about 47%.

As described above, when a single layer, which is made of a material having a refractive index higher than that of the base material 52 of the prism sheet 50, is formed as the s-polarization high reflecting means 53, if the refractive index ns of the transparent medium which is used as the s-polarization high reflecting means 53 increases, a loss (reflection) of the p-polarized light components when the light enters the prism sheet 50 decreases and more s-polarized light components are reflected. Therefore, the light containing a high ratio of p-polarized light components may be obtained as the light which passes through the prism sheet 50. In particular, by increasing the refractive index of the uppermost rear surface of the prism sheet 50, the light, which is output from the light guide plate 20 and has the angle at which the luminance or the luminous intensity becomes the maximum value, is brought into a state where conditions of the Brewster's angle are satisfied or a state where conditions of the Brewster's angle are almost satisfied. Accordingly, the loss of reflection of the p-polarized light components on the rear surface of the prism sheet 50 may be eliminated or may be minimized.

The s-polarized light reflected by the rear surface of the prism sheet 50 enters the prism sheet 50 again through the light guide plate 20 and the reflection sheet 30. When the s-polarized light passes through the light guide plate 20, the polarization state of the s-polarized light varies due to the phase difference produced by the optical anisotropy of the light guide plate 20. The light contains the p-polarized light components and passes through the prism sheet 50, thereby being utilized as illuminating light. In other words, at least a portion of the s-polarized light which is reflected by the rear surface of the prism sheet 50 is converted into the p-polarized light and utilized as illuminating light. Hence, the light intensity of the p-polarized light components may be increased.

However, when the refractive index ns of the transparent medium which is utilized as the s-polarization high reflecting means 53 increases, fluctuation in reflectance of the p-polarized light and the s-polarized light with respect to the variation of the film thickness d becomes larger, and hence the manufacturing margin of the s-polarization high reflecting means 53 becomes smaller. As such, it is reasonable that the refractive index of the transparent medium which is utilized as the s-polarization high reflecting means 53 be increased within a range between 0.2 and 0.7 with respect to the base material 52 of the prism sheet 50.

As exemplified in FIGS. 1 and 4, the diffusion sheet 40 may be disposed on the front surface of the prism sheet 50, as required. The diffusion sheet 40 has a function of enlarging a distribution of the output angle or enhancing in-plane uniformity of the luminance by diffusing the light which is output from the prism sheet 50. Examples of the diffusion sheet 40 to be used include a sheet made of a transparent polymer film, such as a polyethylene terephthalate (PET) film or a polycarbonate (PC) film, with a surface being formed to have unevenness, a sheet formed such that a diffusing layer, which is obtained by mixing the transparent medium with the fine particles which have a translucency and are different in refractive index from the transparent medium, is formed on a surface of a polymer film, a sheet having a diffuseness in which bubbles are trapped in a plate or a film, and a sheet made of a translucent white member or the like obtained by diffusing white pigment in a transparent member such as an acrylic resin member. Because the surface of the prism sheet 50 on which the prism is formed is fragile, the diffusion sheet 40 is allowed to function as a protection layer of the prism sheet 50.

When a film, such as a PET film or a PC film, having an optical anisotropy is used as the diffusion sheet 40, it is important to set the angle of the slow axis to the azimuth angle θ of 0 degrees (or 180 degrees) or the azimuth angle θ of 90 degrees (or 270 degrees), and thus maintain the state of the p-polarized light which is output from the prism sheet 50 in order to realize the illuminating light containing a high light intensity of predetermined linearly polarized light components.

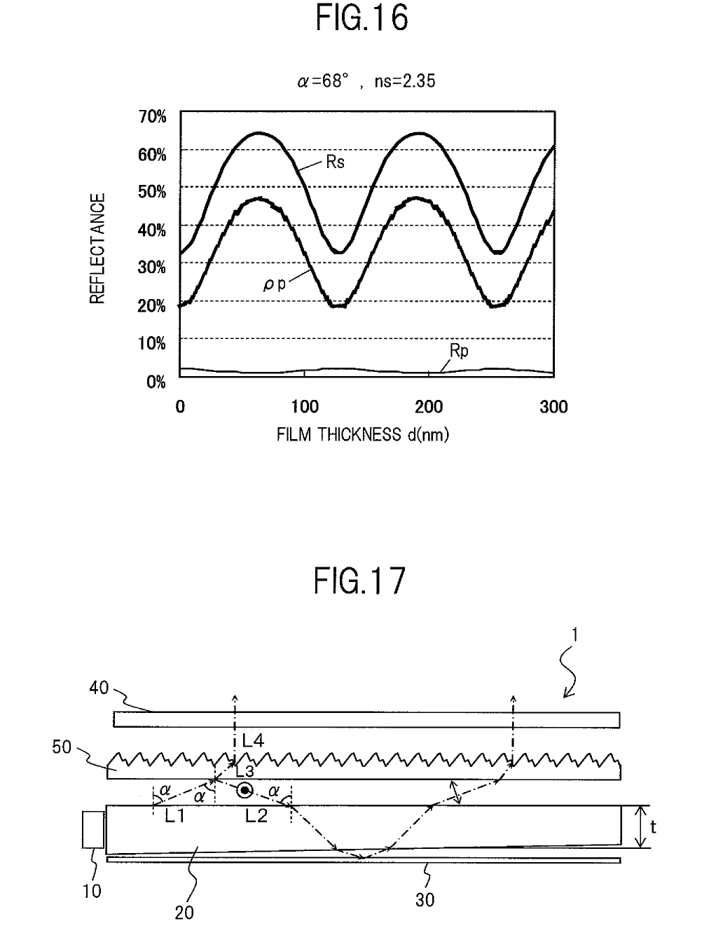

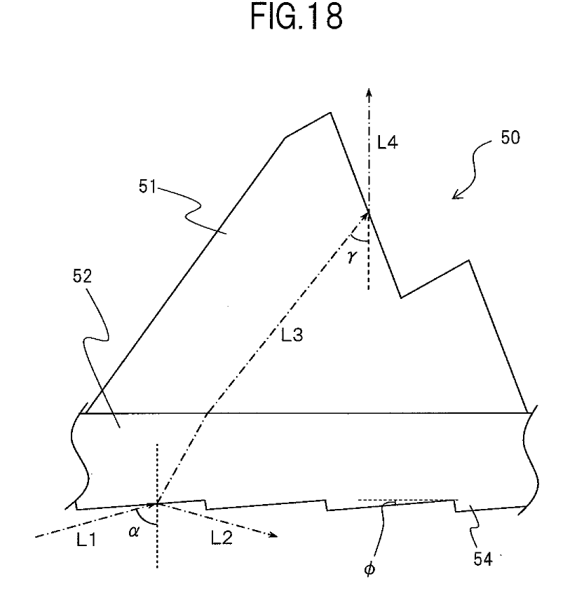

Now, an operation of the illuminating device 1 according to this exemplary embodiment is described below with reference to FIGS. 4, 10, and 17. FIG. 17 is a cross sectional view schematically illustrating a main configuration of the illuminating device 1, which illustrates an example of a light path in which the light is reflected by the reflection sheet 30 after reflected by the prism sheet 50 and enters the prism sheet 50 again.

The light, which is emitted from the light sources 10 and enters the light guide plate 20, propagates within the light guide plate 20. However, the light is reflected by minute inclined surfaces formed into minute steps, an uneven shape, or a lens shape, which are/is provided on the front surface or the rear surface of the light guide plate 20. The light, whose traveling direction is changed by the reflection and which enters the front surface of the light guide plate 20 at an angle less than the angle (critical angle) which is not in conformity with the conditions of the total internal reflection, is output from the front surface of the light guide plate 20.

The light L1 which is output from the light guide plate 20 includes angles of, for example, 77 degrees and 68 degrees, respectively, at which the luminance and the luminous intensity becomes the maximum values. The degrees of polarization ρp of the p-polarized light of each light are about 14% and about 7%, respectively, each of which contains a high ratio of p-polarized light components.

The light L1 which is output from the light guide plate 20 enters the prism sheet 50. At this time, the reflection of the p-polarized light components is controlled at a low ratio and more s-polarized light components are reflected by the s-polarization high reflecting means 53 which is formed on the rear surface of the prism sheet 50. For example, provided that the refractive index of the base material 52 of the prism sheet 50 is 1.65 and the refractive index and the film thickness d of the s-polarization high reflecting means 53 as a layer are 2.35 and about 64 nm, respectively, if an incident angle α of the light which enters the prism sheet 50 is 77 degrees, the reflectance Rp of the p-polarized light is about 2.5%, the reflectance Rs of the s-polarized light is about 77%, and the degree of polarization ρp of the p-polarized light within the base material 52 of the prism sheet 50 is about 61%. In the case of the incident angle α of the light which enters the prism sheet 50 is 68 degrees, the reflectance Rp of the p-polarized light is about 1.1%, the reflectance Rs of the s-polarized light is about 64%, and the degree of polarization ρp of the p-polarized light within the base material 52 of the prism sheet 50 is about 47%, respectively. In other words, light L3, which is output from the light guide plate 20 and enters the prism sheet 50, contains more p-polarized light components than the light L1 which is output from the light guide plate. On the other hand, light L2 which is reflected by the rear surface of the prism sheet 50 contains a high ratio of s-polarized light components.

The light L3 which enters the prism sheet 50 passes through the base material 52 of the prism sheet 50 and the transparent medium which forms the prisms 51, and reaches the inclined surfaces of the prisms 51. At this time, the base material 52 and the prisms 51 are each made of the transparent medium in which no phase difference is produced with respect to the p-polarized light which travels in the traveling direction of the light, in particular, the direction of the azimuth angle of 0 degrees, and hence the light L3 reaches the inclined surfaces of the prisms 51 under a state in which at least a loss of the p-polarized light components is suppressed.

The light L3 which travels within the prism sheet 50 and enters the inclined surfaces SS1 and SS3 of the prism is refracted and output in the front direction. At this time, because of the difference in transmittance between the p-polarized light and the s-polarized light at the interface between the prism 51 and the air layer AIR, light L4 output from the prism sheet 50 contains further more p-polarized light components. When the light L3 which travels within the prism sheet 50 and enters the inclined surface SS2 of the prism is output from the prism sheet 50, the light is refracted in a direction different from the direction of the light output from the inclined surfaces SS1 and SS3. Accordingly, the color variation according to the refraction angle of the light, which is caused by the wavelength dependence of the refractive index of the transparent medium which forms the prism sheet 50, is partially balanced to be lessened. In other words, at the azimuth angles (0 degrees and 180 degrees) orthogonal to the direction of the ridge lines of the prisms 51, the color variation which is produced when the viewing angle (polar angle) is changed is averaged and suppressed.

A distribution of the output angle of the light L4, which is output from the prism sheet 50, is broaden or in-plane uniformity of the luminance of the light L4 is enhanced when the light L4 passes through the diffusion sheet 40, and thereafter the light L4 is output from the diffusion sheet 40.

On the other hand, after the light L2, which is reflected by the rear surface of the prism sheet 50 and contains a high ratio of s-polarized light components, partially passes through the light guide plate 20 and is reflected by the reflection sheet 30, the light L2 passes through the light guide plate 20 again and enters the prism sheet 50. At this time, the light guide plate 20 has a suitable birefringence, and hence at least a portion of the s-polarized light which has been reflected by the rear surface of the prism sheet 50 is converted into the p-polarized light. The light which has been converted into the p-polarized light enters the prism sheet again, and hence not only a ratio of the p-polarized light components but also the absolute light intensity of the p-polarized light in the light L3, which travels within the prism sheet 50, may be increased.

An example of the light guide plate 20 to be used includes a plate which is, for example as described above, formed such that the uniaxially stretched polycarbonate resin or the cyclic olefin resin is used as the base material and minute inclined surfaces formed into minute steps, an uneven shape, or a lens shape are transferred on the surface of the plate in order to cause the light propagating within the light guide plate 20 to be output from the front side of the plate.

When the light L2 which has been reflected by the rear surface of the prism sheet 50 passes through the light guide plate 20, the light guide plate 20 may cause a change of the polarization state of the s-polarized light, and more desirably, converts the light, which enters the prism sheet 50 again after being reflected by the reflection sheet 30, into the p-polarized light. Therefore, the light guide plate 20 may have a retardation value ΔnLt of a range between 100 and 150 nm, provided that, for example, the slow axis angle is set to the azimuth angle θ of a range between 30 and 60 degrees, the thickness is set to t, and the birefringence is set to ΔnL.

In view of the fact that the light, which is reflected by the rear surface of the prism sheet 50, passes through the light guide plate 20, and thereafter enters the reflection sheet 30, is reflected so as to cause the light to be oriented to the prism sheet 50 again, the reflection sheet 30 disposed on the rear surface of the light guide plate 20 is desirably a sheet which may subject light to a specular reflection. An example of the reflection sheet 30 to be used, which has the function of specular reflection includes a sheet which is formed such that a reflective surface having a high reflectance is formed on a supporting base material made of a resin plate, a polymer film or the like. Examples of the reflective surface to be used include a film which is formed such that a metallic thin film having a high reflectance, such as an aluminum film or a silver film, is formed on the supporting base material according to the evaporation method or the sputtering method, or a film which is formed such that a dielectric multilayer is formed on the supporting base material so as to be a high reflecting layer. By laminating on one another a plurality of layers which are made of transparent media having different refractive indexes, such a sheet that functions as specular reflection means may be utilized.

As described above, in the illuminating device 1 according to this exemplary embodiment, with respect to the light L1, which is output from the light guide plate 20 and contains a high ratio of p-polarized light components, the prism sheet 50 is formed so as to provide a small reflection of the p-polarized light components by the rear surface of the prism sheet 50, and provide a large reflection of the s-polarized light components by the rear surface of the prism sheet 50. The light entering the prism sheet 50 is utilized as the illuminating light by suppressing, as small as possible, the loss of the p-polarized light according to the above-mentioned method. On the other hand, the polarization state of the s-polarized light, which has been reflected by the rear surface of the prism sheet 50, varies when the s-polarized light passes through the light guide plate 20. The s-polarized light is at least partially converted into the p-polarized light when entering the prism sheet 50 again. Accordingly, the illuminating device 1 according to this exemplary embodiment may output the illuminating light containing a high ratio and light intensity of p-polarized light components.

### Modification Example of the Prism Sheet

Now, a modification example of the prism sheet 50, which is included in the illuminating device 1 according to this exemplary embodiment, is described below with reference to the attached drawings. FIG. 18 is a partially enlarged cross sectional view illustrating the modification example of the prism sheet 50. The prism sheet 50 in this modification example includes s-polarization high reflecting means 54 which has a configuration different from the above-mentioned s-polarization high reflecting means 53 which is made of a single transparent material, and has a different refractive index of the transparent medium which forms the prisms 51. The prism sheet 50 in the modification example has the same configuration as the above-mentioned prism sheet 50 other than the above-mentioned point, and hence the same reference numerals are provided to the members which have the same functions and the repetitive description of the members is omitted here.

The s-polarization high reflecting means 54 of the prism sheet 50 in this modification example may be obtained by forming minute steps on the rear surface of the prism sheet 50, and more specifically, may be realized by minute inclined surfaces which have inclination angles φ with respect to the light outputting surface of the light guide plate 20. The minute inclined surfaces serve to effectively enlarge the incident angle of the light L1 which is output from the light guide plate 20 and enters the prism sheet 50. In other words, the incident angle of the light into the prism sheet 50 is set to be α+φ, whereas the output angle of the light which is output from the light guide plate 20 is α.

The inclined surface having the inclination angle φ may increase the reflectance of the s-polarized light by enlarging the incident angle of the light L1 which enters the prism sheet 50, and may decrease the refractive index of the transparent medium, which forms the prisms 51, as compared with the refractive index of the above-mentioned example, by selecting a suitable value. For example, when the inclination angle φ is set to 4.5 degrees, if the refractive index of the base material 52 of the prism sheet 50 is 1.65, which is the same value as in the above-mentioned example, the light output from the prism sheet 50 may be oriented in the front direction even when the refractive indexes of the prisms 51 are set to 1.6, which is smaller than the value of the above-mentioned example, with respect to the light into the prism sheet 50 having the incident angle α of 77 degrees. It is industrially effective to allow the material having a smaller refractive index to be used for the prism sheet, resulting in an increase in number of options of the material.

When the refractive index of the base material 52 of the prism sheet 50 is 1.65, if there is no s-polarization high reflecting means 54, the reflectance Rp of the p-polarized light is about 14%, the reflectance Rs of the s-polarized light is about 51%, and the degree of polarization ρp of the p-polarized light within the base material 52 is about 27% with respect to the light into the prism sheet 50 having the incident angle α of 77 degrees. To the contrary, if the inclined surface having the inclination angle φ of 4.5 degrees is formed as the s-polarization high reflecting means 54, the reflectance Rp of the p-polarized light increases, but the degree of polarization ρp of the p-polarized light within the base material 52 increases because the reflectance Rs of the s-polarized light increases in comparison with a case where nothing is formed on the rear surface of the prism sheet 50. Specifically, the reflectance Rp of the p-polarized light increases to about 28%, the reflectance Rs of the s-polarized light increases to about 64%, and the degree of polarization ρp of the p-polarized light within the base material 52 increases to about 33%.

In this modification example, in the light which is output from the light guide plate 20 and contains a high ratio of p-polarized light components, the s-polarized light components of the light are reflected more when the light enters the prism sheet 50, and hence the light, which contains a higher ratio of p-polarized light components than the light output from the light guide plate 20, may be obtained as the light output from the prism sheet 50.

The s-polarized light which has been reflected by the rear surface of the prism sheet 50 partially enters the prism sheet 50 again through the light guide plate 20 and the reflection sheet 30. However, when the light passes through the light guide plate 20, the polarization state is changed due to the phase difference produced by the optical anisotropy of the light guide plate 20. The light contains the p-polarized light components and is used as the illuminating light after the light passes through the prism sheet 50. In other words, at least a portion of the s-polarized light which is reflected by the rear surface of the prism sheet 50 may be converted into the p-polarized light and used as the illuminating light. Hence, the light intensity of the p-polarized light components may be increased.

It is necessary to consider that the s-polarization high reflecting means 54 including minute inclined surfaces may generate moire in a relationship between the inclined surfaces and the prism arrays. To reduce moire, pitches of the minute inclined surfaces as the s-polarization high reflecting means 54 are made different from pitches of the prisms 51. It is desired that, for example, the pitches of the minute inclined surfaces as the s-polarization high reflecting means 54 are about one-fifth of the pitches of the prisms 51.

[Liquid Crystal Display Device]

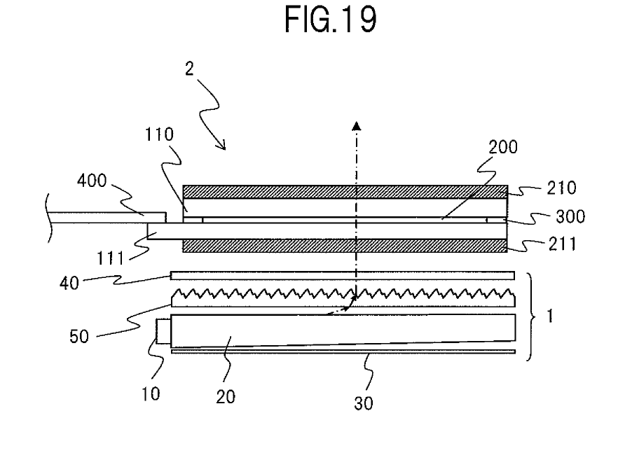

Now, an example of the liquid crystal display device according to an exemplary embodiment of the present invention is described below. FIG. 19 is a cross sectional view schematically illustrating a configuration of the liquid crystal display device according to this exemplary embodiment.

The liquid crystal display device according to this exemplary embodiment includes a display panel which displays an image by controlling the light intensity of transmitted light based on image information, and the illuminating device 1 which illuminates the display panel from behind. An example of the display panel to be used includes a display panel which displays an image by adjusting the light intensity of transmitted light which enters the display panel, in particular, a liquid crystal display panel which has a long life and may perform matrix display. Specifically, a liquid crystal display panel 2 may be a transmissive or transflective type liquid crystal display panel, in which a image is displayed by adjusting the light intensity of transmitted light from the illuminating device 1 in combination with the illuminating device 1. The liquid crystal display panel includes various systems such as a passive drive system and an active matrix drive system. Detailed description of the configurations or operations thereof is omitted here because those have already been publicly known.

Such a liquid crystal display panel 2 that includes a polarizer and displays the image by controlling the polarization state of the light which enters the liquid crystal layer is desired because a image of a high contrast ratio may be obtained with a relatively low driving voltage. A twisted nematic (TN) liquid crystal display panel, a super twisted nematic (STN) liquid crystal display panel, and an electrical controlled birefringence (ECB) liquid crystal display panel may be used as the liquid crystal display panel. An in-plane switching (IPS) liquid crystal display panel and a vertical aligned (VA) liquid crystal display panel, which are characterized by a wide viewing angle, may also be used. The liquid crystal display panel 2 may also be a transflective type liquid crystal display panel, which is an application example of the above-mentioned various liquid crystal display panels. In the following description, a case where the active matrix liquid crystal display panel is used as the liquid crystal display panel 2 is schematically described, but the present invention is not limited thereto.

The liquid crystal display panel 2 includes a first transparent substrate 110 and a second transparent substrate 111 which are made of flat transparent optically isotropic glass or plastic. The first transparent substrate 110 is formed such that a color filter and an alignment layer made of a polyimide series polymer (both not shown) are laminated one above the other. The second transparent substrate 111 is provided with electrodes which form a plurality of pixels arranged in matrix, signal electrodes, scanning electrodes, switching elements including thin film transistors and the like, an alignment layer, and the like (both not shown).

The two transparent substrates 110 and 111 form a space therebetween such that alignment layer forming surfaces of the transparent substrates 110 and 111 are faced to each other and the respective peripheries of the transparent substrates 110 and 111 are bonded through a frame shaped seal material 300 under a state in which the transparent substrates 110 and 111 are constantly spaced to each other by using a spacer (not shown). Liquid crystal is injected into the space and sealed in the space, thereby providing a liquid crystal layer 200. An orientation direction of a longitudinal axis of liquid crystal molecules, which form the liquid crystal layer 200, is defined by an alignment processing provided to the alignment layers formed on the two transparent substrates 110 and 111.

A first polarizer 210 and a second polarizer 211, respectively, are disposed on surfaces of the first transparent substrate 110 and the second transparent substrate 111, the surfaces opposing to the liquid crystal layer 200. The first polarizer 210 and the second polarizer 211 may be formed such that, for example, a triacetyl cellulose protecting layer is provided on each surfaces of a film which is provided with a polarization function by having iodine adsorbed onto stretched polyvinyl alcohol. Preferably, the first polarizer 210 and the second polarizer 211, respectively, are fixed to the first transparent substrate 110 and the second transparent substrate 111 via a transparent bond (not shown). A phase difference layer (not shown) may be appropriately provided between the polarizer and the transparent substrate according to a liquid crystal display mode of the liquid crystal display panel 2.

The liquid crystal display panel 2 includes a display area for forming a two-dimensional image by modulating the transmission amount of the light output from the illuminating device 1, within an area in which the second transparent substrate 111 and the first transparent substrate 110 overlap one another. The second transparent substrate 111 is larger than the first transparent substrate 110 and includes an area for receiving image information such as an image signal in the form of an electric signal from the outside in the area of the second transparent substrate 111 that is on a surface facing to the first transparent substrate 110, the area being not covered by the transparent substrate 110. In other words, the liquid crystal display panel 2 includes a flexible printed circuit board (FPC) 400 in the area on the second transparent substrate 111 where the first transparent substrate 110 is not overlapped, and is electrically connected to the outside through the FPC 400. In this area, a semiconductor chip (not shown) may be provided in order to allow the semiconductor chip to function as a driver, as required.

The illuminating device according to the above-mentioned exemplary embodiment of the present invention is used as the illuminating device 1. An orientation of the absorption axis of linearly polarized light of each of the first polarizer 210 and the second polarizer 211 of the liquid crystal display panel 2 is defined according to a direction of the ridge lines of the prisms 51 in the prism sheet 50 which forms the illuminating device 1. More specifically, the absorption axis of the second polarizer 211 of the liquid crystal display panel 2 disposed on a side of the illuminating device 1 is oriented to a direction in parallel with the direction of the ridge lines of the prisms 51 in a planar view, whereas, the absorption axis of the first polarizer 210 disposed on an opposite side of the illuminating device 1 is oriented to a direction orthogonal to the direction of the ridge lines of the prisms 51.

In the above-mentioned configuration, the light output from the illuminating device 1 irradiates the liquid crystal display panel 2. The light, which irradiates the liquid display panel 2 and passes through the second polarizer 211, enters the first polarizer 200 after passing through the liquid crystal layer 200. At this time, the direction of the liquid crystal molecules may be changed if an electric field corresponding to the image information that is received from a image information generation unit (not shown) is applied to the liquid crystal layer. Accordingly, the polarization state of the light which passes through the liquid crystal layer 200 is changed and an amount of light passing through the first polarizer 210 is controlled, thereby displaying the image corresponding to the image information that is input from the outside.

The light output from the illuminating device 1, as described above, is the light which contains a higher ratio of linearly polarized light (p-polarized light) which has a polarization plane of the electric vector in a direction orthogonal to the direction of the ridge lines of the prisms 51 in the prism sheet 50 which forms the illuminating device 1. Accordingly, if the absorption axis of the second polarizer 211 of the liquid crystal display panel 2, which is disposed on the side of the illuminating device 1, is made in parallel with the direction of the ridge lines of the prisms 51, as described above, the amount of light which is absorbed by the second polarizer 211 to be a loss may be minimized. In other words, the transmittance of the liquid crystal display panel 2 is increased with respect to the light output from the illuminating device 1, and hence an effect of producing brighter image display may be realized. Further, electric power of the illuminating device (backlight) may be saved because of the increase of the transmittance when the image is displayed in the same brightness.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical sheet, comprising:
prism arrays which are provided on one surface of the optical sheet, and each of which includes at least two inclined surfaces and a ridge line extending in one direction; and
s-polarization high reflecting means provided on a surface opposite to the surface on which the prism arrays are formed, for increasing a ratio of p-polarized light components of light which is transmitted through the optical sheet by increasing a reflection of s-polarized light components with respect to light which enters the opposite surface at a predetermined angle.

2. The optical sheet according to claim 1, wherein the s-polarization high reflecting means comprises a layer which is made of a transparent material having a refractive index higher than that of a base material of the optical sheet and a thickness corresponding to the predetermined angle.

3. The optical sheet according to claim 1, wherein the s-polarization high reflecting means comprises an inclined surface which is inclined in a direction in which an incident angle, to the optical sheet, of the light coming from a direction crossing the direction of the ridge line of each of the prism arrays is made larger with respect to the surface on which the prism arrays are formed.

4. An optical sheet, comprising:
prism arrays which are provided on one surface of the optical sheet, and each of which has at least two inclined surfaces and a ridge line extending in one direction; and
a base material comprising a transparent medium by which no phase difference is produced with respect to a p-polarized light entering a surface opposite to the one surface at a predetermined incident angle.

5. The optical sheet according to claim 4, wherein the transparent medium which forms the base material has an optical anisotropy and a slow axis that is substantially in parallel with or substantially orthogonal to the direction of the ridge line of each of the prism arrays.

6. The optical sheet according to claim 5, wherein the transparent medium which forms the base material has a biaxial anisotropy and the slow axis that is substantially in parallel with the direction of the ridge line of each of the prism arrays.

7. The optical sheet according to claim 4, wherein the base material comprises an optically isotropic transparent medium.

8. The optical sheet according to claim 4, wherein a portion of one side of the ridge line of each of the prism arrays includes at least three inclined surfaces, and at least one inclined surface among the three inclined surfaces is inclined in an opposite direction with respect to other inclined surfaces when viewed from a front surface of the optical sheet.

9. An illuminating device, comprising:
a light guide plate for outputting light, which enters the light guide plate from one side surface, from a front surface of the light guide plate;
an optical sheet disposed on the front surface of the light guide plate; and
a reflection sheet disposed on a rear surface of the light guide plate,
wherein a surface of the optical sheet opposite to the light guide plate includes prism arrays each having at least two inclined surfaces and a ridge line extending in a direction along the one side surface of the light guide plate, and
wherein a surface of the optical sheet on a side of the light guide plate includes s-polarization high reflecting means for increasing a ratio of p-polarized light components of light which is transmitted through the optical sheet by increasing a reflection of s-polarized light components with respect to the light which is output from the light guide plate and travels in a direction with a predetermined angle with respect to the front surface of the light guide plate.

10. The illuminating device according to claim 9, wherein the light guide plate changes a polarization state of light that is reflected by the surface of the optical sheet on the side of the light guide plate, is transmitted through the light guide plate, is reflected by the reflection sheet, is transmitted through the light guide plate again, and then enters the optical sheet.

11. The illuminating device according to claim 10, wherein the light guide plate converts at least a portion of the s-polarized light components reflected by the surface of the optical sheet on the side of the light guide plate into p-polarized light components before the light reflected by the reflection sheet enters the optical sheet again.

12. The illuminating device according to claim 11, wherein the light guide plate has a birefringence and a slow axis that is inclined with respect to the one side surface of the light guide plate.

13. The illuminating device according to claim 9, wherein the predetermined angle is an angle at which an index value with respect to an amount of the light which is output from the light guide plate becomes a maximum value.

14. The illuminating device according to claim 9, wherein the s-polarization high reflecting means comprises a layer which is made of a transparent material having a refractive index higher than that of a base material of the optical sheet and a thickness corresponding to the predetermined angle.

15. The illuminating device according to claim 9, wherein the s-polarization high reflecting means comprises an inclined surface which is inclined in a direction in which an incident angle, to the optical sheet, of the light output from the light guide plate is made larger with respect to the surface on which the prism arrays are formed.

16. An illuminating device, comprising:
a light guide plate for outputting the light, which enters the light guide plate from one side surface, from a front surface of the light guide plate; and
an optical sheet disposed on the front surface of the light guide plate,
wherein the optical sheet comprises:
prism arrays which are provided on a surface of the optical sheet opposite to the light guide plate, and each of which has at least two inclined surfaces and a ridge line extending in a direction along the one side surface; and
a base material comprising a transparent medium by which no phase difference is produced with respect to a p-polarized light which enters a surface of the optical sheet on a side of the light guide plate at a predetermined incident angle.

17. The illuminating device according to claim 16, wherein the transparent medium which forms the base material has an optical anisotropy and a slow axis that is substantially in parallel with or substantially orthogonal to the direction of the ridge line of each of the prism arrays.

18. The illuminating device according to claim 17, wherein the transparent medium which forms the base material has a biaxial anisotropy and the slow axis that is substantially in parallel with the direction of the ridge line of each of the prism arrays.

19. The illuminating device according to claim 16, wherein the base material comprises an optically isotropic transparent medium.

20. A liquid crystal display device, comprising:
an illuminating device according to claim 9; and
a liquid crystal display panel for displaying an image by controlling transmission of light from the illuminating device,
wherein the liquid crystal display panel comprises a polarizer which is disposed on a side of the illuminating device, the polarizer having an absorption axis that is oriented in a direction according to the direction of the ridge line of each of the prism arrays.

21. A liquid crystal display device, comprising:
an illuminating device according to claim 16; and
a liquid crystal display panel for displaying an image by controlling transmission of light from the illuminating device;
wherein the liquid crystal display panel comprises a polarizer disposed on a side of the illuminating device, the polarizer having an absorption axis that is oriented in a direction according to the direction of the ridge line of each of the prism arrays.
